(19) United States
(12) Patent Application Publication
(10) Pub. No.: US 2025/0060151 A1
(43) Pub. Date: Feb. 20, 2025

(54) REFRIGERATOR AND METHOD OF CONTROLLING THE SAME

(71) Applicant: Samsung Electronics Co., Ltd., Suwon-si (KR)

(72) Inventors: Sookang KIM, Suwon-si (KR); Ganghyun KIM, Suwon-si (KR); Taeyoung HEO, Suwon-si (KR)

(73) Assignee: Samsung Electronics Co., Ltd., Suwon-si (KR)

(21) Appl. No.: 18/780,107

(22) Filed: Jul. 22, 2024

Related U.S. Application Data
(63) Continuation of application No. PCT/KR2024/010112, filed on Jul. 15, 2024.

(30) Foreign Application Priority Data
Aug. 18, 2023 (KR) 10-2023-0108543

(51) Int. Cl. F25D 29/00

(52) U.S. Cl. CPC F25D 29/005; F25D 29/008; F25D 2400/361

(57) ABSTRACT

A refrigerator including an output interface; a user interface including at least one key mapped to a predefined operation to be performed when the refrigerator is in a normal state, the user interface being configured to receive a user input via the at least one key; and at least one processor configured to identify whether the refrigerator is in an abnormal state, based on identifying the refrigerator as being in an abnormal state, control the output interface to output a notification of the abnormal state of the refrigerator, and, based on a user input received via the at least one key while the refrigerator is identified as being in the abnormal state, control the output interface to turn off the notification of the abnormal state of the refrigerator.

### CROSS-REFERENCE TO RELATED APPLICATIONS

This application is a continuation application, under 35 U.S.C. § 111 (a), of International Application No. PCT/KR2024/010112, filed on Jul. 15, 2024, which claims priority under 35 U.S.C. § 119 to Korean Patent Application No. 10-2023-0108543, filed on Aug. 18, 2023, the disclosures of which are incorporated by reference herein in their entireties.

### TECHNICAL FIELD

An embodiment of the disclosure relates to a refrigerator, a method of controlling a refrigerator, and a recording medium storing a computer program for performing the method of controlling a refrigerator.

### BACKGROUND ART

In general, a refrigerator is a home appliance which stores food and maintains freshness of the food, and constantly maintains the temperature inside the refrigerator at a user-set temperature.

A common refrigerator may include a fridge compartment, a freezer compartment, and doors for opening/closing the fridge compartment and the freezer compartment. A refrigerator may have a refrigerating function and a freezing function. Also, a refrigerator may have a temperature change function enabling the adjustment of a temperature inside the refrigerator as desired by a user, an ice making function for making ice, a water purification function enabling purification of water, or the like.

Because repairs are required when a malfunction occurs in such refrigerators, refrigerators may output a visual and auditory notification indicating that an abnormality has occurred in the refrigerator. A normal user of the refrigerator cannot release the visual and auditory notification until the abnormal state of the refrigerator has been repaired by a service engineer with specialized knowledge. Accordingly, the user experiences inconvenience as the user is exposed to noise as the user continuously hears the auditory notification while using the refrigerator, or has to turn off the power of the refrigerator.

Also, when a door of the refrigerator is open during a preset time, the inside temperature of the refrigerator is changed by an external temperature, and the refrigerator may identify that an abnormal condition has occurred, and thus, may output an auditory notification until the door of the refrigerator is closed. However, in a case where an auditory notification is continuously output even when the user intentionally opens the door of the refrigerator during a preset time, the user experiences inconvenience as the user is exposed to noise. Also, even when the door is closed, in a case where the auditory notification is continuously output as an abnormality occurs in a function of the refrigerator, the user experiences inconvenience because the auditory notification cannot be turned off until an abnormal state of the refrigerator is repaired by a service engineer, and thus the user is exposed to noise.

### DISCLOSURE

### Technical Solution

According to an embodiment of the disclosure, a refrigerator includes an output interface; a user interface including at least one key mapped to a predefined operation to be performed when the refrigerator is in a normal state, the user interface being configured to receive a user input via the at least one key; and at least one processor configured to identify whether the refrigerator is in an abnormal state, based on identifying the refrigerator as being in an abnormal state, control the output interface to output a notification of the abnormal state of the refrigerator, and, based on a user input received via the at least one key while the refrigerator is identified as being in the abnormal state, control the output interface to turn off the notification of the abnormal state of the refrigerator.

According to an embodiment of the disclosure, the output interface may include a display. The at least one processor may be configured to, based on the notification of the abnormal state of the refrigerator being turned off, control the display to output information indicating that the notification of the abnormal state of the refrigerator is turned off.

According to an embodiment of the disclosure, the at least one processor may be configured to, based on the refrigerator not being identified as being in the abnormal state, control the refrigerator to perform the predefined operation according to the user input received via the at least one key.

According to an embodiment of the disclosure, the at least one processor may be configured to identify information about the refrigerator, the information being stored in a memory, and, based on determining an abnormality in the identified information, identify that the refrigerator is in the abnormal state.

According to an embodiment of the disclosure, the information about the refrigerator may include information for determining a program for driving the refrigerator according to a function of the refrigerator.

According to an embodiment of the disclosure, the at least one processor may be configured to, when the identified information about the refrigerator is first state information or second state information, or the identified information about the refrigerator identified from at least one storage space among a plurality of spaces of the memory is different from the identified information about the refrigerator identified from other storage spaces among the plurality of spaces, determine that there is an abnormality in the information about the refrigerator.

According to an embodiment of the disclosure, the refrigerator may include at least one door. The at least one processor may be configured to, based on the at least one door being open during a preset time or longer, identify that the refrigerator is in the abnormal state.

According to an embodiment of the disclosure, the at least one processor may be configured to identify a time during which the user input received via the at least one key is maintained while the refrigerator is identified as being in the abnormal state, and, when the time during which the user input received via the at least one key is maintained is less than 2n seconds (wherein n is a positive number), control the output interface to turn off the notification of the abnormal state of the refrigerator during a preset time, and control the output interface to output the notification of the abnormal state of the refrigerator after an elapse of the preset time.

According to an embodiment of the disclosure, the at least one processor may be configured to, when the time during which the user input received via the at least one key is maintained is greater than the 2n seconds, control the output interface to maintain a state in which the notification of the abnormal state of the refrigerator is turned off until the user input received via the at least one key is obtained again while the notification about occurrence of the abnormal state of the refrigerator is turned off, or until the abnormal state of the refrigerator has been resolved.

According to an embodiment of the disclosure, the output interface may include a display. The user interface may include a dummy key that is not mapped to a predefined operation to be performed when the refrigerator is in a normal state. The at least one processor may be configured to, based on identifying the refrigerator as being in the abnormal state, control the display to output information indicating that the dummy key is able to control the notification of the abnormal state of the refrigerator, and, based on a user input received via the dummy key while the refrigerator is identified as being in the abnormal state, control the output interface to turn off the notification of the abnormal state of the refrigerator.

According to an embodiment of the disclosure, the refrigerator may further include a communication module. The at least one processor may be configured to control the communication module to transmit, to an external device, the notification of the abnormal state of the refrigerator, and control the communication module to receive, from the external device, a control command for turning off the notification of the abnormal state of the refrigerator.

According to an embodiment of the disclosure, the refrigerator may further include a communication module. The at least one processor may be configured to control the communication module to transmit, to an external device, a notification release history related to the notification of the abnormal state of the refrigerator.

According to an embodiment of the disclosure, provided is a method of controlling a refrigerator including an output interface, and a user interface including at least one key mapped to a predefined operation to be performed when the refrigerator is in a normal state, the method including identifying whether the refrigerator is in an abnormal state; based on identifying the refrigerator as being in an abnormal state, controlling the output interface to output a notification of the abnormal state of the refrigerator; and based on a user input received via the at least one key while the refrigerator is identified as being in the abnormal state, controlling the output interface to turn off the notification of the abnormal state of the refrigerator.

According to an embodiment of the disclosure, the output interface may include a display. The method may further include, based on the notification of the abnormal state of the refrigerator being turned off, controlling the display to output information indicating that the notification of the abnormal state of the refrigerator is turned off.

According to an embodiment of the disclosure, the method may further include, based on the refrigerator not being identified as being in the abnormal state, performing the predefined operation according to the user input received via the at least one key.

According to an embodiment of the disclosure, the identifying of whether the refrigerator is in an abnormal state may include identifying information about the refrigerator, the information being stored in a memory, and, based on determining an abnormality in the identified information, identifying that the refrigerator is in the abnormal state.

According to an embodiment of the disclosure, the refrigerator may include at least one door. The method may further include, based on the at least one door being open during a preset time or longer, identifying that the refrigerator is in the abnormal state.

According to an embodiment of the disclosure, the output interface may include a display. The input interface may include a dummy key that is not mapped to a predefined operation to be performed when the refrigerator is in a normal state. The method may further include, based on identifying the refrigerator as being in the abnormal state, controlling the display to output information indicating that the dummy key is able to control the notification of the abnormal state of the refrigerator, and, based on a user input received via the dummy key while the refrigerator is identified as being in the abnormal state, controlling the output interface to turn off the notification of the abnormal state of the refrigerator.

According to an embodiment of the disclosure, the refrigerator may include a communication module. The method may further include controlling the communication module to transmit, to an external device, a notification release history related to the notification of the abnormal state of the refrigerator.

According to an embodiment of the disclosure, provided is a computer-readable recording medium having recorded thereon a program to control a computer to perform a method of controlling a refrigerator including an output interface, and a user interface including at least one key mapped to a predefined operation to be performed when the refrigerator is in a normal state, the method including identifying whether the refrigerator is in an abnormal state; based on identifying the refrigerator as being in an abnormal state, controlling the output interface to output a notification of the abnormal state of the refrigerator; and based on a user input received via the at least one key while the refrigerator is identified as being in the abnormal state, controlling the output interface to turn off the notification of the abnormal state of the refrigerator.

### DESCRIPTION OF DRAWINGS

FIG. 1 is a diagram for describing an operation of controlling a notification about occurrence of an abnormal state of a refrigerator, according to an embodiment of the disclosure.

FIG. 2 is a schematic block diagram illustrating a configuration of a refrigerator, according to an embodiment of the disclosure.

FIG. 3 is a detailed block diagram illustrating a configuration of a refrigerator, according to an embodiment of the disclosure.

FIG. 4 is a flowchart illustrating a method of controlling a refrigerator, according to an embodiment of the disclosure.

FIG. 5 is a flowchart illustrating a method by which a refrigerator controls a notification about occurrence of an abnormal state, according to an embodiment of the disclosure.

FIG. 6 is a flowchart illustrating a method by which a refrigerator controls, via a single key, a notification about occurrence of an abnormal state, according to an embodiment of the disclosure.

FIG. 7 is a diagram for describing an operation performed by a refrigerator in a normal state, according to an embodiment of the disclosure.

FIG. 8A is a diagram for describing an operation of outputting a notification when an abnormal state has occurred in a refrigerator, according to an embodiment of the disclosure.

FIG. 8B is a diagram for describing an operation of turning off a notification output from a refrigerator, according to an embodiment of the disclosure.

FIG. 8C is a diagram for describing an operation of turning on a notification output from a refrigerator, according to an embodiment of the disclosure.

FIG. 9 is a diagram of an example showing a display and a user interface of a refrigerator, according to an embodiment of the disclosure.

FIG. 10 is a flowchart of a method by which a refrigerator controls a notification about occurrence of an abnormal state, according to an embodiment of the disclosure.

FIG. 11A is a diagram for describing an operation of outputting a notification when an abnormal state has occurred in a refrigerator, according to an embodiment of the disclosure.

FIG. 11B is a diagram for describing an operation of turning off a notification output from a refrigerator, according to an embodiment of the disclosure.

FIG. 12 is a flowchart illustrating a method by which a refrigerator controls a notification about occurrence of an abnormal state, according to an embodiment of the disclosure.

FIG. 13A is a diagram for describing an operation in which a refrigerator outputs a notification when an abnormal state has occurred in the refrigerator, and displays information indicating that the notification can be controlled, according to an embodiment of the disclosure.

FIG. 13B is a diagram for describing an operation of turning off a notification output from a refrigerator, according to an embodiment of the disclosure.

FIG. 14 is a diagram for describing an operation in which a refrigerator displays information indicating that a notification can be controlled, according to an embodiment of the disclosure.

FIG. 15 is a flowchart illustrating a method by which a refrigerator controls a notification, according to a time during which an input for a key for controlling the notification is maintained, according to an embodiment of the disclosure.

FIG. 16 is a diagram illustrating a refrigerator, a control device, a device management server, a terminal, and a service center, according to an embodiment of the disclosure.

FIG. 17 is a diagram for describing operations of a refrigerator and a control device, according to an embodiment of the disclosure.

FIG. 18 is a flowchart for describing operations of a refrigerator, a device management server, and a terminal, according to an embodiment of the disclosure.

FIG. 19 is a diagram for describing an operation of a terminal according to an operation of a refrigerator, according to an embodiment of the disclosure.

FIG. 20 is a flowchart for describing operations of a refrigerator, a device management server, and a service center, according to an embodiment of the disclosure.

FIG. 21 is a flowchart illustrating a method by which a refrigerator controls a notification about occurrence of an abnormal state, and repairs the abnormal state, according to an embodiment of the disclosure.

### MODE FOR INVENTION

The terms used in the disclosure will now be briefly defined, and an embodiment of the disclosure will be described in detail.

Although the terms used in the disclosure are selected, as much as possible, from general terms that are widely used at present while taking into consideration the functions obtained in accordance with an embodiment of the disclosure, these terms may be replaced by other terms based on intentions of one of ordinary skill in the art, customs, emergence of new technologies, or the like. Also, in particular cases, the terms are discretionally selected by the applicant of the disclosure, and the meaning of those terms will be described in detail in the corresponding part of the detailed description of an embodiment of the disclosure. Therefore, the terms used in the disclosure are not merely designations of the terms, but the terms are defined based on the meaning of the terms and content throughout the disclosure.

Throughout the disclosure, the expression “at least one of a, b or c” indicates only a, only b, only c, both a and b, both a and c, both b and c, all of a, b, and c, or variations thereof.

Throughout the disclosure, when a part “includes” or “comprises” an element, unless there is a particular description contrary thereto, the part may further include other elements, not excluding the other elements. Also, the terms such as “ . . . unit,” “module,” or the like used in the disclosure indicate a unit, which processes at least one function or operation, and the unit may be implemented by hardware or software, or by a combination of hardware and software.

Throughout the disclosure, the processor may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

Hereinafter, the disclosure will now be described more fully with reference to the accompanying drawings for one of ordinary skill in the art to be able to perform an embodiment of the disclosure without any difficulty. However, an embodiment of the disclosure may be embodied in many different forms and should not be construed as being limited to the embodiment set forth herein. In the drawings, for a more clear description of an embodiment of the disclosure, parts or units that are not related to the descriptions are omitted, and like reference numerals will denote like elements throughout the disclosure.

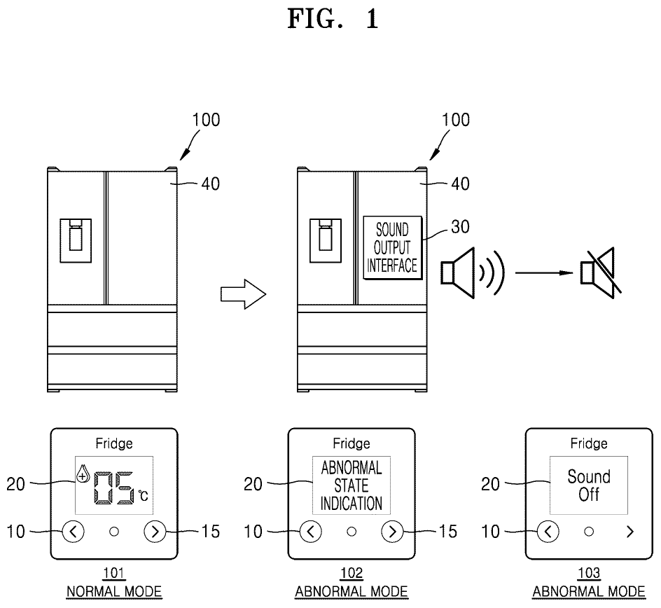

FIG. 1 is a diagram for describing an operation of controlling a notification about occurrence of an abnormal state of a refrigerator, according to an embodiment of the disclosure.

Referring to FIG. 1, the refrigerator 100 according to an embodiment of the disclosure internally stores various kinds of food. The refrigerator 100 may include a fridge compartment for cold storage of food in a temperature above zero, and a freezer compartment for freezing storage of food in a temperature below zero. The refrigerator 100 may further include a temperature-adjustment compartment capable of adjusting a temperature inside the refrigerator to a user desired level, an ice maker configured to make ice, a water purifier configured to purify water, etc., but the disclosure is not limited thereto.

According to an embodiment of the disclosure, the refrigerator 100 may identify whether there is an abnormal state in the refrigerator 100. When the abnormal state has occurred in the refrigerator 100, the refrigerator 100 may output a visual notification and/or an auditory notification which informs a user of occurrence of the abnormal state in the refrigerator 100.

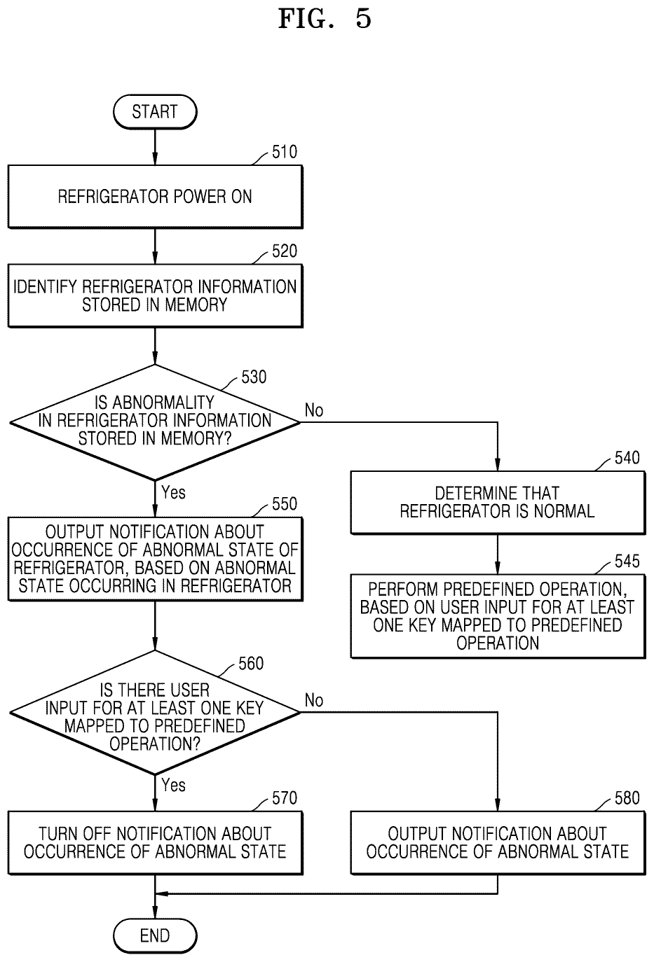

For example, the abnormal state of the refrigerator 100 may include a malfunction occurring in a function of the refrigerator 100, the malfunction including a fridge compartment temperature sensor malfunction, a freezer compartment temperature sensor malfunction, a humidity sensor malfunction, a freezer compartment evaporator fan malfunction, an ice-maker malfunction, a refrigerator communication error, a cooling air supplier malfunction, or the like. The aforementioned malfunction of the refrigerator 100 may be a malfunction which needs to be repaired by a service engineer. When the abnormal state has occurred, the refrigerator 100 may output a display of the abnormal state via a display 20, and may output a notification (or, an alarm) about the abnormal state via a sound output interface 30. For example, the sound output interface 30 may include a speaker, a buzzer, or the like. The notification about the abnormal state of the refrigerator 100 may be output via the sound output interface 30 until the malfunction of the refrigerator 100 is repaired. This will be described in detail with reference to FIGS. 5 to 9.

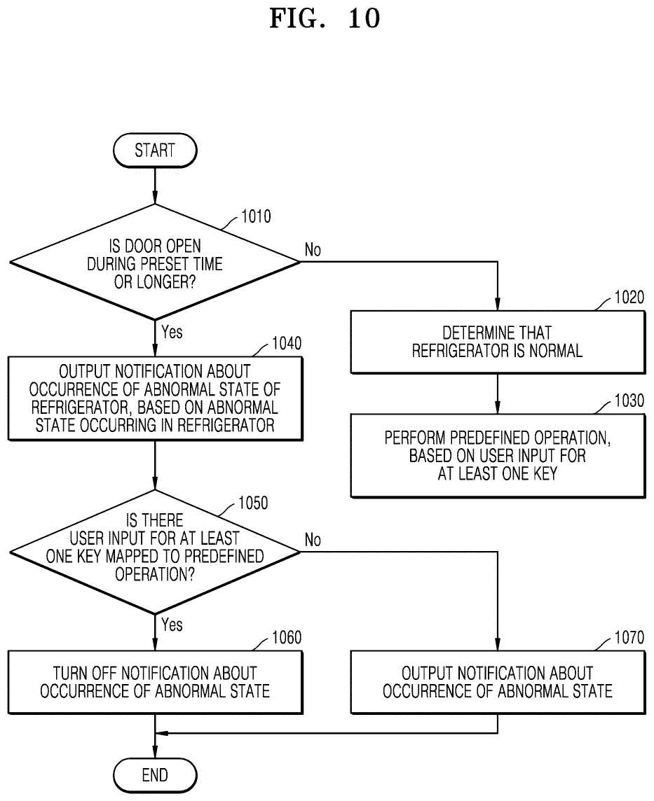

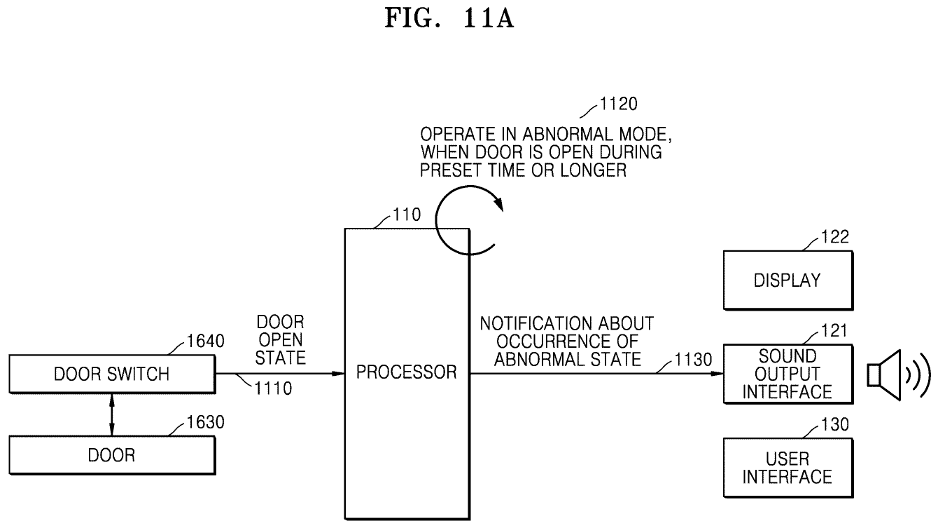

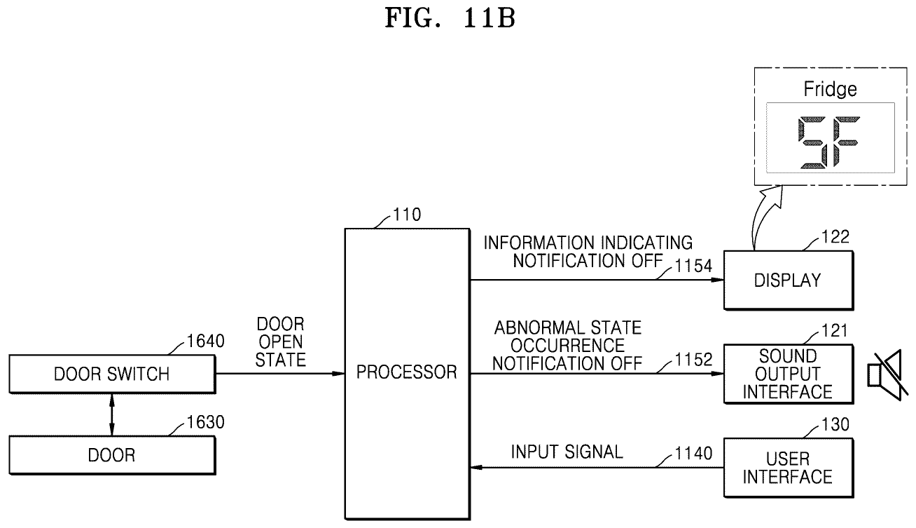

Also, for example, the abnormal state of the refrigerator 100 may include a door open state in which a door 40 of the refrigerator 100 is open during a preset time or longer. When the refrigerator 100 is open during the preset time or longer, a notification about an abnormal state may be output via the sound output interface 30 until the door 40 of the refrigerator 100 is closed. This will be described in detail with reference to FIGS. 10 to 11B.

Also, for example, the abnormal state of the refrigerator 100 may include a malfunction of a door switch configured to identify an open/closed state of the door 40 of the refrigerator 100. The malfunction of the door switch may indicate a malfunction that needs to be repaired by a service engineer. When the door switch is out of order, the refrigerator 100 may continuously output a notification about the abnormal state via the sound output interface 30 even when the door 40 of the refrigerator 100 is closed. The notification about the abnormal state of the refrigerator 100 may be output via the sound output interface 30 until the door switch is repaired. This will be described in detail with reference to FIGS. 10 to 11B.

For example, in 101 of FIG. 1, when the refrigerator 100 identifies that there is no abnormal state in the refrigerator 100, the refrigerator 100 may operate in a normal mode. For example, when the refrigerator 100 receives a user input via a left direction key 10, the refrigerator 100 may perform a predefined operation mapped to the left direction key 10. For example, the left direction key 10 arranged at the refrigerator 100 may be mapped to an operation of adjusting a temperature of a storage compartment of the refrigerator 100. For example, the refrigerator 100 may decrease the temperature of the storage compartment, in response to the input via the left direction key 10. Also, the refrigerator 100 may display an adjusted internal temperature on the display 20. For example, the refrigerator 100 may display, on the display 20, a state in which a current temperature of a fridge compartment is decreased to 5° C.

For example, in 102 of FIG. 1, when the refrigerator 100 identifies that there is an abnormal state in the refrigerator 100, the refrigerator 100 may operate in an abnormal mode. For example, the refrigerator 100 may output a display about the abnormal state on the display 20. For example, the refrigerator 100 may output a notification about the abnormal state via the sound output interface 30.

According to an embodiment of the disclosure, the refrigerator 100 in the abnormal mode may control the notification about the abnormal state, which is output via the sound output interface 30, to be turned off or on. The refrigerator 100 may use a key for controlling a notification to be turned off or on in the abnormal mode, the key being for controlling a predefined operation in the normal mode. The refrigerator 100 may control the notification about the abnormal state, by using a key mapped to different operations in the normal mode and the abnormal mode. According to whether the refrigerator 100 currently operates in the normal mode or the abnormal mode, the refrigerator 100 may differently operate, in response to one key. As the refrigerator 100 controls the notification about the abnormal state, it is possible to resolve inconvenience in which a user is exposed to noise because the notification cannot be turned off until the abnormal state of the refrigerator 100 is repaired.

For example, in 102 of FIG. 1, when the refrigerator 100 operates in the abnormal node, the left direction key 10 may not be mapped to the function of adjusting a temperature of the storage compartment. The left direction key 10 may be mapped to a function of controlling the notification about the abnormal state to be turned off or on, the notification being output via the sound output interface 30.

For example, in 103 of FIG. 1, when the refrigerator 100 receives a user input via the left direction key 10 in the abnormal mode, the refrigerator 100 may control the sound output interface 30 to turn off or on the notification about the abnormal state. For example, when the left direction key 10 is input once, the notification about the abnormal state may be turned off. In this case, the refrigerator 100 may display, on the display 20, information indicating that the notification about the abnormal state is turned off. For example, the refrigerator 100 may display ‘Sound off’ on the display 20. Also, while the notification about the abnormal state is turned off, when the left direction key 10 is input once more, the notification about the abnormal state may be turned on again. In this case, the refrigerator 100 may display, on the display 20, information indicating that the notification about the abnormal state is turned on (not shown).

The refrigerator 100 may turn off or on a notification about an abnormal state via a plurality of keys. For example, the left direction key 10 that is used to decrease a temperature of a storage compartment in a normal mode may be used to turn off a notification about an abnormal state in an abnormal mode. Also, a right direction key 15 used to increase a temperature of the storage compartment in a normal mode may be used to turn on a notification about an abnormal state in an abnormal mode.

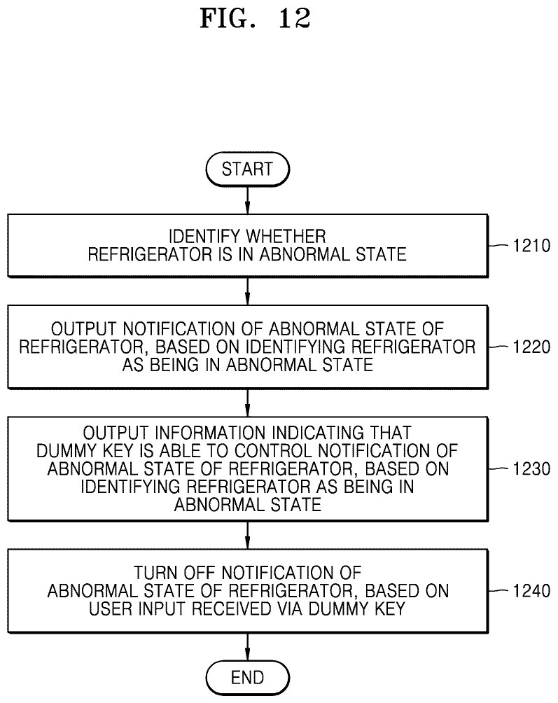

The refrigerator 100 may use a key, which is not used in a normal mode, to control a notification to be turned off or on in an abnormal mode. In the disclosure, a key that is not used in a normal mode may be referred to as a dummy key. The dummy key is not used as a key for controlling a predefined operation, and may not be mapped to the predefined operation. This will be described in detail with reference to FIG. 12.

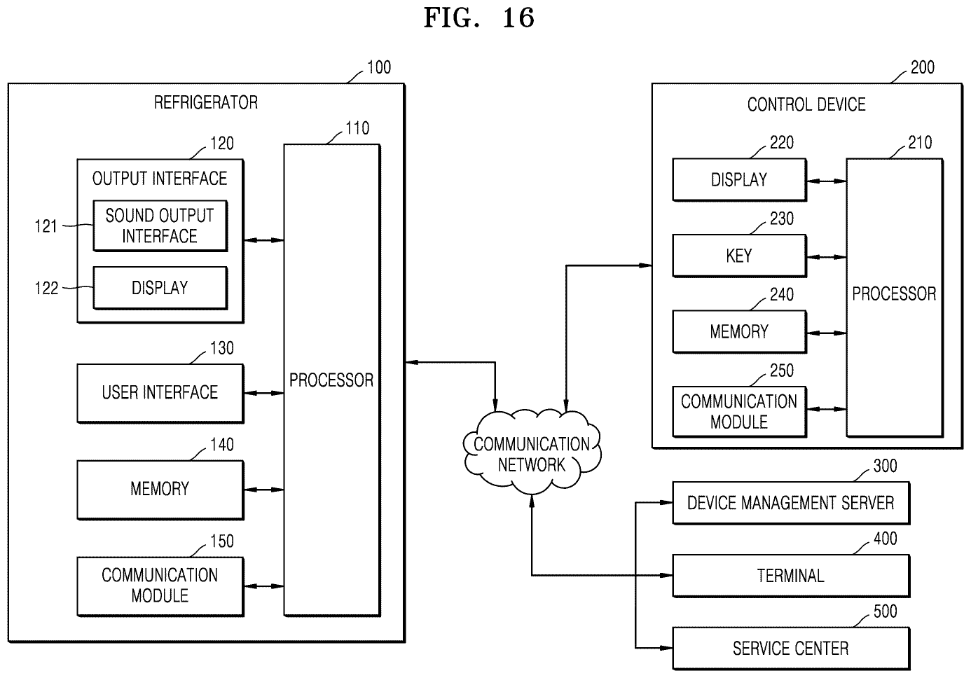

According to an embodiment of the disclosure, the left direction key 10 and the display 20 may be elements provided in the refrigerator 100. However, the disclosure is not limited thereto, and the left direction key 10 and the display 20 may be elements provided in a control device (see 200 of FIG. 16) configured to remotely control the refrigerator 100.

According to an embodiment of the disclosure, the refrigerator 100 may control an auditory notification to be turned off by a user input, even before an abnormal state of the refrigerator 100 is resolved. As the refrigerator 100 according to an embodiment of the disclosure turns off the auditory notification by the user input, inconvenience in which a user is exposed to noise due to the auditory notification may be resolved.

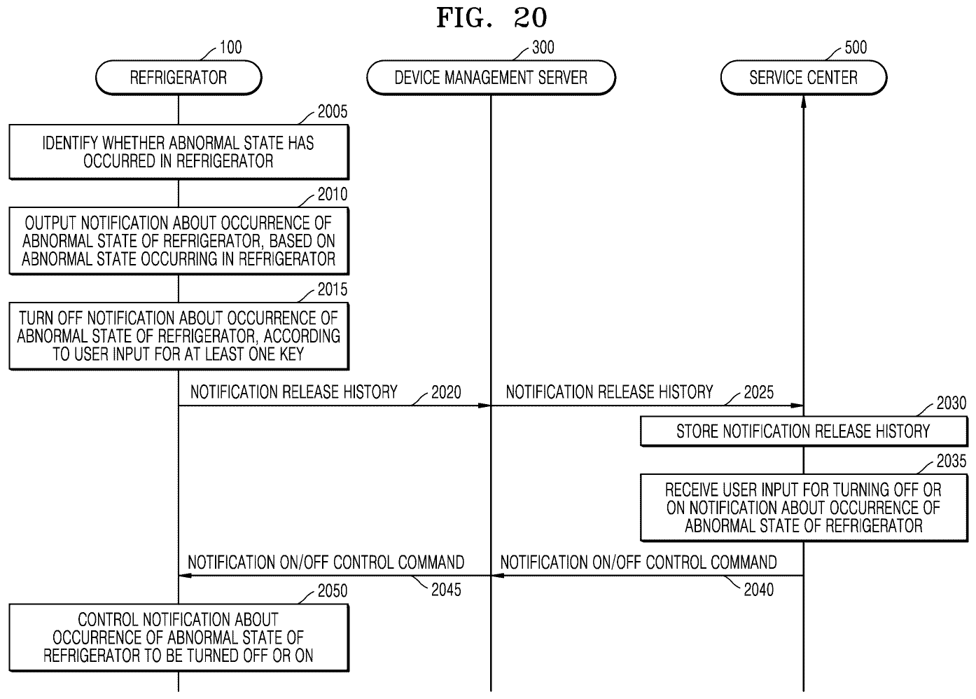

When the auditory notification is turned off by the user input, the refrigerator 100 according to an embodiment of the disclosure may transmit information indicating that the auditory notification is turned off to a service center so as to prevent repair of the abnormal state of the refrigerator 100 from being omitted, even when the auditory notification is turned off. This will be described in detail with reference to FIG. 20.

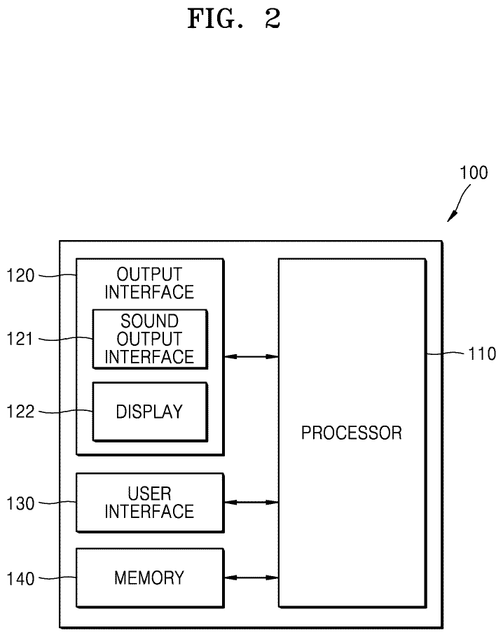

FIG. 2 is a schematic block diagram illustrating a configuration of a refrigerator, according to an embodiment of the disclosure.

Referring to FIG. 2, the refrigerator 100 according to an embodiment of the disclosure may include a processor 110, an output interface 120, a user interface 130, and a memory 140.

The processor 110 controls all operations of the refrigerator 100. The processor 110 may be implemented as at least one processor. The processor 110 may perform a preset operation by executing an instruction or a command which is stored in the memory 140. Also, the processor 110 controls operations of elements provided in the refrigerator 100. The processor 110 may control the elements of the refrigerator 100 by executing a program stored in the memory 140. The processor 110 may include a central processing unit (CPU), a graphics processing unit (GPU), or the like. Also, the processor 110 may include a separate neural processing unit (NPU) configured to perform an operation of an artificial intelligence (AI) model.

The output interface 120 is for outputting an audio signal or a video signal, and may include a sound output interface 121, a display 122, or the like. The output interface 120 may output a notification about occurrence of an abnormal state of the refrigerator 100 via the sound output interface 121 or the display 122.

The sound output interface 121 may output an audio signal stored in the memory 140. The sound output interface 121 may output an audio signal related to a function performed by the refrigerator 100. For example, the sound output interface 121 may include a speaker, a buzzer, or the like.

According to an embodiment of the disclosure, the sound output interface 121 may output a notification about occurrence of an abnormal state of the refrigerator 100, based on the abnormal state occurring in the refrigerator 100. For example, the sound output interface 121 may output a notification about a malfunction of the refrigerator 100 which needs to be repaired by a service engineer. Also, the sound output interface 121 may output a notification about a state in which a door of the refrigerator 100 is left open during a preset time or longer.

The display 122 may include at least one of a liquid crystal display (LCD), a light-emitting diode (LED) display, an organic light-emitting diode (OLED) display, a flexible display, a three-dimensional (3D) display, or an electrophoretic display. When the display 122 and a touch pad form a layer structure to constitute a touch screen, the display 122 may be used as both the output interface 120 and the user interface 130.

According to an embodiment of the disclosure, the display 122 may display a notification about occurrence of an abnormal state of the refrigerator 100, based on the abnormal state occurring in the refrigerator 100. For example, the display 122 may display a notification about a malfunction of the refrigerator 100 which requires repair by a service engineer. Alternatively, for example, the display 122 may display a notification about a state in which a door of the refrigerator 100 is open during a preset time or longer. Alternatively, for example, the display 122 may display a notification about a door switch malfunction state of the refrigerator 100.

The user interface 130 may receive a user input for controlling the refrigerator 100. The user interface 130 may be at least one of a button receiving a push operation of a user, a touch pad (a touch capacitive type touch pad, a pressure resistive type touch pad, an infrared beam sensing type touch pad, a surface acoustic wave type touch pad, an integral strain gauge type touch pad, a piezo effect type touch pad, or the like) detecting a user's touch, a jog wheel receiving a rotation operation of the user, a jog switch, a dome switch, a microphone identifying a voice, or a motion detection sensor sensing a motion, but the disclosure is not limited thereto.

According to an embodiment of the disclosure, the user interface 130 may include a plurality of keys. Each of the plurality of keys may be formed as one of the button receiving a push operation of a user, the touch pad detecting a user's touch, the jog wheel, the jog switch, and the dome switch. A user may control various functions of the refrigerator 100 by using the plurality of keys provided at the user interface 130. For example, the plurality of keys may be associated with or mapped to predefined operations. For example, the predefined operations may include storage compartment temperature adjustment, menu selection, starting of an ice-making operation, stopping of the ice-making operation, starting of water extraction from a water purifier, or the like. In the disclosure, the plurality of keys may be provided at the touch screen for which the display 122 and the touch pad form the layer structure, but the disclosure is not limited thereto.

The memory 140 stores various information, data, instructions, programs, or the like which are necessary for operations of the refrigerator 100. The memory 140 may include at least one of a volatile memory or a non-volatile memory, or a combination thereof. The memory 140 may include at least one type of storage media including a flash memory type, a hard disk type, a multimedia card micro type, a card type memory (for example, a secure digital (SD) or an extreme digital (XD) memory), a random access memory (RAM), a static RAM (SRAM), a read-only memory (ROM), an electrically erasable programmable ROM (EEPROM), a programmable ROM (PROM), a magnetic memory, a magnetic disk, and an optical disk. Also, the memory 140 may correspond to a web storage or a cloud server which performs a storage function on the Internet.

According to an embodiment of the disclosure, the memory 140 may store information about predefined operations corresponding to a plurality of keys. For example, the memory 140 may store information about the predefined operations mapped to the plurality of keys. For example, when one key from among the plurality of keys is input by a user, the processor 110 may perform a predefined operation mapped to one key. For example, when the processor 110 receives a user input via a key mapped to an operation of decreasing a temperature of a storage compartment, the processor 110 may control a cooling air supplier to decrease the temperature of the storage compartment.

According to an embodiment of the disclosure, the processor 110 may identify whether an abnormal state has occurred in the refrigerator 100. Based on the abnormal state occurring in the refrigerator 100, the processor 110 may control the output interface 120 to output a notification about occurrence of the abnormal state in the refrigerator 100. The processor 110 may control the output interface 120 to turn off the notification about occurrence of the abnormal state in the refrigerator 100, according to a user input for at least one key mapped to a predefined operation.

According to an embodiment of the disclosure, the plurality of keys may include at least one key mapped to different operations in a normal mode and an abnormal mode. For example, the at least one key may be mapped to a predefined operation in the normal mode (or normal state), and may be mapped to an operation of controlling a notification about occurrence of an abnormal state of the refrigerator 100 to be turned on or off in the abnormal mode. In an embodiment of the disclosure, according to whether the refrigerator 100 currently operates in the normal mode or the abnormal mode, the refrigerator 100 may differently operate, in response to the at least one key. For example, when the processor 110 receives a user input via the at least one key, the processor 110 may perform an operation of decreasing a temperature of a storage compartment in the normal mode, and may control the output interface 120 to control a notification about occurrence of an abnormal state to be turned off or on in the abnormal mode. According to an embodiment of the disclosure, the memory 140 may store information about a mapped operation in the normal mode and a mapped operation in the abnormal mode with respect to the at least one key.

Alternatively, the plurality of keys may include a dummy key that is not mapped to a predefined operation in the normal mode but is used to control a notification about occurrence of an abnormal state in the refrigerator 100 to be turned off or on in the abnormal mode. The dummy key may indicate a key that is not mapped to the predefined operation. The dummy key may be a key that has a touch sensor but is not connected to a preset function. For example, when the processor 110 receives a user input via the dummy key, the processor 110 may not operate in the normal mode but may control the output interface 120 to control a notification about occurrence of an abnormal state to be turned off or on in the abnormal mode.

According to an embodiment of the disclosure, the refrigerator 100 may control the notification about occurrence of the abnormal state to be turned off by a user input even before the abnormal state of the refrigerator 100 is resolved. As the refrigerator 100 according to an embodiment of the disclosure turns off the notification about occurrence of the abnormal state, by a user input, inconvenience in which a user is exposed to auditory noise may be resolved.

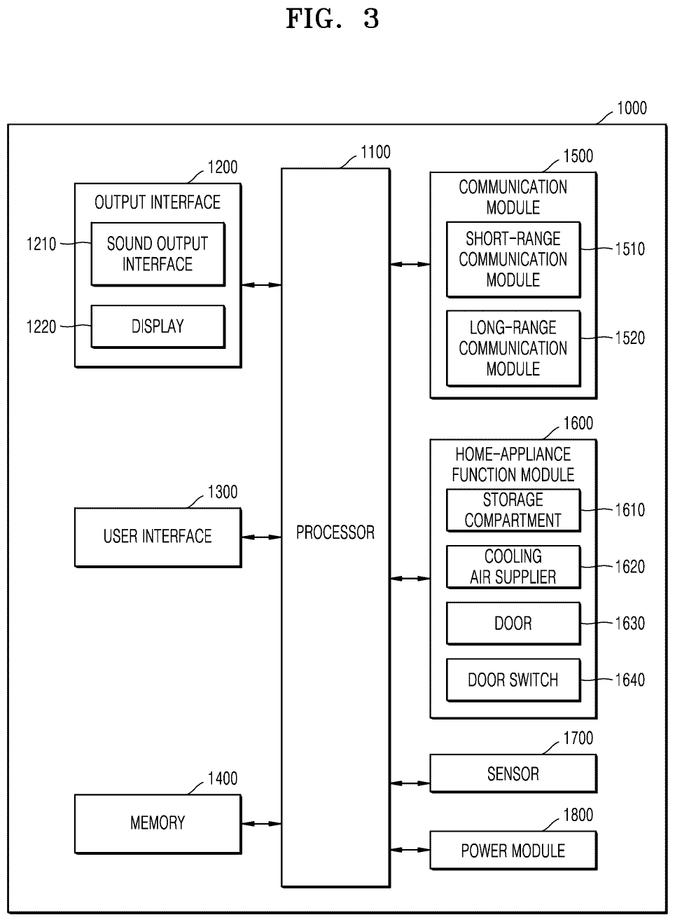

FIG. 3 is a detailed block diagram illustrating a configuration of a refrigerator, according to an embodiment of the disclosure.

Referring to FIG. 3, a refrigerator 1000 according to an embodiment of the disclosure may include a processor 1100, an output interface 1200, a user interface 1300, a memory 1400, a communication module 1500, a home-appliance function module 1600, a sensor 1700, and a power module 1800. However, not all elements shown in FIG. 3 are necessary elements. The refrigerator 1000 may be embodied with more elements than the elements shown in FIG. 3 or may be embodied with fewer elements than the shown elements.

The processor 1110 of FIG. 3 may correspond to the processor 110 of FIG. 2, the output interface 1200 of FIG. 3, which may include a sound output interface 1210 and a display 1220, may correspond to the output interface 120 of FIG. 2, the user interface 1300 of FIG. 3 may correspond to the user interface 130 of FIG. 2, and the memory 1400 of FIG. 3 may correspond to the memory 140 of FIG. 2.

Hereinafter, the communication module 1500, the home-appliance function module 1600, the sensor 1700, and the power module 1800 will now be sequentially described, except for what is described in FIG. 2.

The communication module 1500 may include at least one of a short-range communication module 1510 or a long-range communication module 1520, or a combination thereof. The communication module 1500 may include at least one antenna configured to wirelessly communicate with one or more other devices.

The short-range communication module 1510 may include a Bluetooth communication module, a Bluetooth low energy (BLE) communication module, a near-field communication (NFC) module, a WLAN (Wi-Fi) communication module, a ZigBee communication module, an infrared data association (IrDA) communication module, a Wi-Fi direct (WFD) communication module, an ultra-wideband (UWB) communication module, an Ant+ communication module, a microwave (uWave) communication module, or the like, but the disclosure is not limited thereto.

The long-range communication module 1520 may include a communication module configured to perform various types of long-range communication, and may include a mobile communication unit. The mobile communication unit transmits or receives a wireless signal with at least one of a base station, an external terminal, or a server, over a mobile communication network. Here, the wireless signal may include a voice call signal, a video call signal, or various types of data according to text/multimedia message transmission and reception.

The home-appliance function module 1600 includes an operation module configured to perform a core function of the refrigerator 100. The home-appliance function module 1600 may include a storage compartment 1610, a cooling air supplier 1620, a door 1630, and a door switch 1640.

The storage compartment 1610 may include one or more storage compartments. The storage compartment 1610 may include a fridge compartment, a freezer compartment, a temperature-adjustment compartment, etc., in which different temperatures are maintained.

The cooling air supplier 1620 may be configured to supply cooling air to the storage compartment 1610. The cooling air supplier 1620 may generate cooling air via a cooling cycle including a compression, condensation, expansion, and evaporation process of a refrigerant. The cooling air supplier 1620 may include a cooling cycle device having a compressor, a condenser, an expansion device, and an evaporator.

The door 1630 may be configured to open/close one open side of the storage compartment 1610. The door 1630 may be installed to be rotatable or slidable to a front surface of the refrigerator 100.

The refrigerator 1000 may detect an open/closed state of the door 1630 by the door switch 1640. The door switch 1640 may include a reed switch configured to detect an open/closed state of the door 1630 by using a magnet. For example, the open/closed state of the door 1630 may be detected in a manner that, when the door 1630 is open, the door switch 1640 is electrically connected, and, when the door 1630 is closed, the door switch 1640 is open.

The sensor 1700 may include a temperature sensor configured to detect a temperature of the storage compartment 1610, a humidity sensor configured to detect humidity, or the like. The sensor 1700 outputs a measured sensing value to the processor 1100.

The power module 1800 is connected to a power source, and thus, supplies power to the refrigerator 1000.

The processor 1100 controls all operations of the refrigerator 1000. The processor 1100 may control elements of the refrigerator 1000 by executing a program stored in the memory 1400.

According to an embodiment of the disclosure, the at least one processor 110 identifies whether an abnormal state has occurred in the refrigerator 100 by executing at least one instruction. Based on the abnormal state occurring in the refrigerator 100, the at least one processor 110 controls the output interface 120 to output a notification about occurrence of the abnormal state of the refrigerator 100. According to a user input for at least one key mapped to a predefined operation, the at least one processor 110 controls the output interface 120 to turn off the notification about occurrence of the abnormal state of the refrigerator 100.

According to an embodiment of the disclosure, the at least one processor 110 may be configured to execute at least one instruction to control the display 122 to output information indicating that the notification about occurrence of the abnormal state of the refrigerator 100 is turned off, based on the notification about occurrence of the abnormal state of the refrigerator 100 being turned off.

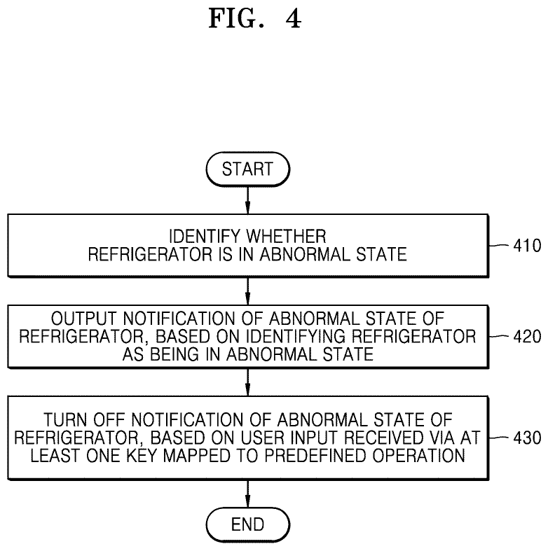

FIG. 4 is a flowchart illustrating a method of controlling a refrigerator, according to an embodiment of the disclosure.

Referring to FIG. 4, in operation 410, the refrigerator 100 according to an embodiment of the disclosure may identify whether the refrigerator is in an abnormal state. According to an embodiment of the disclosure, determining whether a refrigerator is in an abnormal state may correspond to determining whether an abnormal state of the refrigerator has occurred.

According to an embodiment of the disclosure, the abnormal state of the refrigerator 100 may include a malfunction state of the refrigerator 100 based on occurrence of an abnormality in information about the refrigerator 100, a state in which the door 1630 of the refrigerator 100 is open during a preset time or longer, a malfunction state in the door switch 1640 of the refrigerator 100, or the like.

According to an embodiment of the disclosure, the refrigerator 100 may read information about the refrigerator 100 stored in the memory 140, and may identify a model of the refrigerator 100. The refrigerator 100 may set a program for driving the refrigerator 100, based on the information about the refrigerator 100. For example, the information about the refrigerator 100 may include information for determining the program for driving the refrigerator 100, based on a function of the refrigerator 100. For example, the information about the refrigerator 100 may be stored in the form of hexadecimal number such as 0x01, 0x02, . . . 0xFD, 0xFE in an erasable programmable read-only memory (EEPROM) that is a memory in the refrigerator.

According to an embodiment of the disclosure, the refrigerator 100 may identify whether there is an abnormality in the information about the refrigerator 100.

For example, when there is no abnormality in the information about the refrigerator 100 which is stored in the memory 140, the refrigerator 100 may identify that the refrigerator 100 is normal. For example, when the information about the refrigerator 100 which is stored in the memory 140 is one of values of 0x01, 0x02, . . . 0xFD, 0xFE, excluding 0xFF and 0x00, the refrigerator 100 may determine that there is no abnormality in the information about the refrigerator 100. When there is no abnormality in the information about the refrigerator 100 which is stored in the memory 140, the refrigerator 100 may operate in a normal mode. For example, the refrigerator 100 may perform a predefined operation, based on a user input for at least one key mapped to the predefined operation in the normal mode. For example, when the refrigerator 100 receives a user input via at least one key, the refrigerator 100 may perform an operation of decreasing a temperature of a storage compartment.

For example, when there is an abnormality in the information about the refrigerator 100 which is stored in the memory 140, the refrigerator 100 may identify that there is an abnormal state in the refrigerator 100. For example, the abnormal state in the refrigerator 100 may indicate a malfunction which needs to be repaired by a service engineer, the malfunction including a fridge compartment temperature sensor malfunction, a freezer compartment temperature sensor malfunction, a humidity sensor malfunction, a freezer compartment evaporator fan malfunction, an ice-maker malfunction, a refrigerator communication error, a cooling air supplier malfunction, or the like. For example, when the information about the refrigerator 100 which is stored in the memory 140 is first state information or second state information, the refrigerator 100 may determine that there is an abnormality in the information about the refrigerator 100. For example, the first state information may be 0xFF and the second state information may be 0x00, but the disclosure is not limited thereto. The abnormal state due to a malfunction of the refrigerator 100 may be an error that cannot be resolved until the refrigerator 100 is repaired by a service engineer.

Also, according to an embodiment of the disclosure, the refrigerator 100 may identify whether the door 1630 is open during a preset time or longer. When the door 1630 is open during the preset time or longer, the refrigerator 100 may determine that there is an abnormal state in the refrigerator 100. The refrigerator 100 may identify whether the door 1630 is open during the preset time or longer via the door switch 1640 configured to detect an open/closed state of the door 1630. An abnormal state due to door opening may be resolved when the door 1630 is closed. The refrigerator 100 may output a notification about occurrence of the abnormal state until the door 1630 is closed.

Also, according to an embodiment of the disclosure, when there is an open malfunction in the door switch 1640, the refrigerator 100 may incorrectly determine that the door 1630 is open even when the door 1630 is closed. Due to the open error in the door switch 1640, the processor 110 may receive a preset time abnormality detection signal from the door switch 1640. When the processor 110 receives the preset time abnormality detection signal from the door switch 1640, the processor 110 may incorrectly determine that the door 1630 is open during the preset time or longer. The abnormal state due to a malfunction of the door switch 1640 may be an error that cannot be resolved until the door switch 1640 is repaired by a service engineer. The refrigerator 100 may output a notification about occurrence of the abnormal state even when the door 1630 is closed.

In operation 420, the refrigerator 100 according to an embodiment of the disclosure may operate in an abnormal mode, based on identifying the refrigerator 100 as being in an abnormal state. The refrigerator 100 may control the output interface 120 to output the notification about occurrence of the abnormal state in the refrigerator 100. For example, the refrigerator 100 may control the sound output interface 121 to output the notification about occurrence of the abnormal state, according to the abnormal mode. For example, the refrigerator 100 may output the notification, based on occurrence of one of an abnormal state due to a malfunction of the refrigerator 100, an abnormal state due to door opening of the refrigerator 100, and an abnormal state due to a malfunction of the door switch 1640. The sound output interface 121 may output a notification about occurrence of the abnormal state.

For example, the refrigerator 100 may control the display 122 to display the notification about occurrence of the abnormal state, according to the abnormal mode. For example, when it is the abnormal state due to the malfunction of the refrigerator 100, the refrigerator 100 may display the ‘Ch’ error indicating a notification about occurrence of the abnormal state. For example, when it is the abnormal state due to door opening of the refrigerator 100 or the abnormal state due to the malfunction of the door switch 1640, the refrigerator 100 may display a text other than the ‘Ch’ error.

In operation 430, the refrigerator 100 according to an embodiment of the disclosure may control the output interface 120 to turn off the notification about occurrence of the abnormal state of the refrigerator 100, based on a user input via the at least one key mapped to a predefined operation while the refrigerator 100 is identified as being in the abnormal state. For example, according to the user input via the at least one key, the refrigerator 100 may control the sound output interface 121 to turn off the notification about occurrence of the abnormal state of the refrigerator 100. The sound output interface 121 may not output the notification about occurrence of the abnormal state of the refrigerator 100.

According to an embodiment of the disclosure, the user interface 130 may include a plurality of keys. Each of the plurality of keys may be configured as a form of one of a button for receiving a push operation of a user, a touch pad for detecting a user touch, a jog wheel, a jog switch, and a dome switch. A user may control various functions of the refrigerator 100 by using the plurality of keys arranged in the user interface 130. For example, the plurality of keys may be associated with or mapped to predefined operations. For example, the predefined operations may include storage compartment temperature adjustment, menu selection, starting of an ice-making operation, stopping of the ice-making operation, starting of water extraction from a water purifier, or the like.

According to an embodiment of the disclosure, the memory 140 may store information about the predefined operations corresponding to the plurality of keys. For example, the memory 140 may store information about the predefined operations mapped to the plurality of keys. For example, when at least one key is input by a user in a normal mode, the processor 110 may perform a predefined operation mapped to the at least one key.

According to an embodiment of the disclosure, the plurality of keys included in the user interface 130 may include at least one key mapped to different operations in a normal mode and an abnormal mode. For example, the at least one key may be mapped to a predefined operation in the normal mode, and may be mapped to an operation of controlling a notification about occurrence of an abnormal state of the refrigerator 100 to be turned on or off in the abnormal mode. In an embodiment of the disclosure, according to whether the refrigerator 100 currently operates in the normal mode or the abnormal mode, the refrigerator 100 may differently operate, in response to the at least one key. For example, when the refrigerator 100 receives a user input via the at least one key in the normal mode, the refrigerator 100 may perform an operation of decreasing a temperature of a storage compartment. When the refrigerator 100 receives a user input via the at least one key in the abnormal mode, the refrigerator 100 may control the sound output interface 121 to turn off or on a notification about occurrence of the abnormal state.

According to an embodiment of the disclosure, the refrigerator 100 may control the notification about occurrence of the abnormal state to be turned off by a user input even before the abnormal state of the refrigerator 100 is resolved. For example, the refrigerator 100 may control the sound output interface 121 to turn off the notification about occurrence of the abnormal state, by a user input, even before a malfunction of the refrigerator 100 is repaired. For example, even before the door 1630 is closed, the refrigerator 100 may control the sound output interface 121 to turn off the notification about occurrence of the abnormal state, by a user input. For example, even before a malfunction of the door switch 1640 is repaired, the refrigerator 100 may control the sound output interface 121 to turn off the notification about occurrence of the abnormal state, by a user input. As the refrigerator 100 according to an embodiment of the disclosure turns off the notification about occurrence of the abnormal state, by a user input, inconvenience in which a user is exposed to auditory noise may be resolved.

When the refrigerator 100 according to an embodiment of the disclosure turns off the notification about occurrence of the abnormal state, the refrigerator 100 may transmit information indicating that the notification about occurrence of the abnormal state is turned off, to a service center via a device management server (see 300 of FIG. 16). Even when the notification is turned off by user control, the refrigerator 100 according to an embodiment of the disclosure may transmit the information to the service center so as to prevent repair of the abnormal state of the refrigerator 100 from being omitted.

FIG. 5 is a flowchart illustrating a method by which a refrigerator controls a notification about occurrence of an abnormal state, according to an embodiment of the disclosure.

Referring to FIG. 5, in operation 510, the refrigerator 100 according to an embodiment of the disclosure may turn on power of the refrigerator 100.

In operation 520, the refrigerator 100 according to an embodiment of the disclosure may identify information about the refrigerator 100 which is stored in the memory 140. For example, the refrigerator 100 may read the information about the refrigerator 100 which is stored in the memory 140, may identify a model of the refrigerator 100, and may set a program for driving the refrigerator 100. Also, the refrigerator 100 may read the information about the refrigerator 100 which is stored in the memory 140, and may identify whether an abnormal state has occurred in the refrigerator 100. For example, the abnormal state of the refrigerator 100 may be a malfunction which needs to be repaired by a service engineer.

For example, the information about the refrigerator 100 may include information for determining a program for driving the refrigerator 100, according to a function of the refrigerator 100. For example, the information about the refrigerator 100 may be represented as a value for identifying a refrigerator model. For example, various types of a refrigerator may exist according to a function (e.g., a freezing function, a refrigerating function, a temperature-adjustment function, etc.) of the refrigerator 100. A common software program is installed in various types of refrigerator models, and in order to drive a program matched with each refrigerator model, information about a model of the refrigerator 100 may be stored in a memory of the refrigerator 100. The refrigerator 100 may read the information about the refrigerator 100 which is stored in the memory, and may determine a program for driving the refrigerator 100 having a particular function.

For example, the information about the refrigerator 100 may be stored in the form of hexadecimal number such as 0x01, 0x02, . . . 0xFD, 0xFE in an EEPROM that is a memory in the refrigerator. For example, the refrigerator 100 may identify that the information about the refrigerator is, for example, 0x01, and may execute a program matched with the refrigerator model. For example, information about the refrigerator 100 which is stored in a memory of a first refrigerator model having only a fridge compartment and a freezer compartment may be different from information about the refrigerator 100 which is stored in a memory of a second refrigerator model having a fridge compartment, a freezer compartment, and an ice maker. Therefore, a program for driving the first refrigerator model may be different from a program for driving the second refrigerator model.

In operation 530, the refrigerator 100 according to an embodiment of the disclosure may identify whether there is an abnormality in the information about the refrigerator 100 which is stored in the memory 140.

In operations 530 and 540, when there is no abnormality in the information about the refrigerator 100 which is stored in the memory 140, the refrigerator 100 according to an embodiment of the disclosure may determine that the refrigerator 100 is normal. For example, when the information about the refrigerator 100 which is stored in the memory 140 is one of values of 0x01, 0x02, . . . 0xFD, 0xFE, excluding 0xFF and 0x00, the refrigerator 100 may determine that there is no abnormality in the information about the refrigerator 100. When there is no abnormality in the information about the refrigerator 100 which is stored in the memory 140, the refrigerator 100 may operate in a normal mode.

In operation 545, the refrigerator 100 according to an embodiment of the disclosure may perform a predefined operation, based on a user input via at least one key mapped to the predefined operation in the normal mode.

According to an embodiment of the disclosure, the user interface 130 may include a plurality of keys. Each of the plurality of keys may be configured as a form of one of a button for receiving a push operation of a user, a touch pad for detecting a user touch, a jog wheel, a jog switch, and a dome switch. A user may control various functions of the refrigerator 100 by using the plurality of keys arranged in the user interface 130. For example, the plurality of keys may be associated with or mapped to predefined operations. For example, the predefined operations may include storage compartment temperature adjustment, menu selection, starting of an ice-making operation, stopping of the ice-making operation, starting of water extraction from a water purifier, or the like.

According to an embodiment of the disclosure, the memory 140 may store information about the predefined operations corresponding to the plurality of keys. For example, the memory 140 may store information about the predefined operations mapped to the plurality of keys. For example, when at least one key from among the plurality of keys is used for input by a user, the processor 110 may perform a predefined operation mapped to the at least one key. For example, when the processor 110 receives a user input via a key mapped to an operation of decreasing a temperature of a storage compartment, the processor 110 may control the cooling air supplier to decrease the temperature of the storage compartment.

In operations 530 and 550, when there is an abnormality in the information about the refrigerator 100 which is stored in the memory 140, the refrigerator 100 according to an embodiment of the disclosure may identify that there is an abnormal state in the refrigerator 100. For example, the abnormal state in the refrigerator 100 may indicate a malfunction which needs to be repaired by a service engineer, the malfunction including a fridge compartment temperature sensor malfunction, a freezer compartment temperature sensor malfunction, a humidity sensor malfunction, a freezer compartment evaporator fan malfunction, an ice-maker malfunction, a refrigerator communication error, a cooling air supplier malfunction, or the like.

For example, when the information about the refrigerator 100 which is stored in the memory 140 is first state information or second state information, the refrigerator 100 may determine that there is an abnormality in the information about the refrigerator 100. For example, the first state information may be 0xFF and the second state information may be 0x00, but the disclosure is not limited thereto.

Alternatively, for example, the refrigerator 100 may read information about the refrigerator 100 which is stored in a plurality of storage spaces existing in the memory 140. The memory 140 may have a storage space for each address, and may read and write data by accessing a storage space corresponding to each address via an address bus. The refrigerator 100 may identify whether information about the refrigerator 100 which is identified from at least one storage space among the plurality of storage spaces in the memory 140 is equal to information about the refrigerator 100 which is identified from other storage spaces among the plurality of storage spaces. When the refrigerator 100 determines that the information about the refrigerator 100 which is identified from the at least one storage space is different from the information about the refrigerator 100 which is identified from other storage spaces, the refrigerator 100 may determine that there is an abnormality in the information about the refrigerator 100.

For example, the refrigerator 100 may identify information about the refrigerator 100 from three storage spaces. When information about the refrigerator 100 which is identified from storage space no. 1 is 0x01, information about the refrigerator 100 which is identified from storage space no. 3 is 0x01, and information about the refrigerator 100 which is identified from storage space no. 2 is 0x02, the refrigerator 100 may determine that there is an abnormality in the information about the refrigerator 100.

In operation 550, the refrigerator 100 according to an embodiment of the disclosure may operate in an abnormal mode, based on the abnormal state occurring in the refrigerator 100. For example, the refrigerator 100 may output a notification about occurrence of the abnormal state of the refrigerator 100.

For example, the refrigerator 100 may control the display 122 to display the notification about occurrence of the abnormal state, according to the abnormal mode. For example, the refrigerator 100 may display the ‘Ch’ error indicating the notification about occurrence of the abnormal state. Also, for example, the refrigerator 100 may control the sound output interface 121 to output the notification about occurrence of the abnormal state, according to the abnormal mode.

The refrigerator 100 according to an embodiment of the disclosure may operate as a default specification model, according to the abnormal mode. For example, for each refrigerator model, a refrigerator may vary in the number of storage compartments, existence or non-existence of a refrigerating function, a freezing function, a temperature-adjustment function, an ice-making function, a water-purifying function, or the like. When there is an abnormality in the information about the refrigerator 100, it is difficult for the processor 110 to identify a type of a current refrigerator, and thus, it is difficult to determine which program to be executed. Therefore, the processor 110 may assume that the current refrigerator is the default specification model that is a model with the most functions (that is, a high-end specification model), and may execute a program for driving the default specification model. Accordingly, by executing the program for driving all functions of the refrigerator 100, the refrigerator 100 may be safely operated even before the abnormal state of the refrigerator 100 is repaired.

In operation 560, the refrigerator 100 according to an embodiment of the disclosure may identify whether there is a user input via at least one key mapped to a predefined operation in the abnormal mode. For example, the refrigerator 100 may identify whether there is one user input or a plurality of user inputs for the at least one key. Alternatively, for example, the refrigerator 100 may identify whether the input via the at least one key is maintained for several seconds.

In operation 570, according to an embodiment of the disclosure, when the refrigerator 100 determines that there is the user input for the at least one key mapped to the predefined operation, the refrigerator 100 may control the output interface 120 to turn off the notification about occurrence of the abnormal state of the refrigerator 100.

In operation 580, according to an embodiment of the disclosure, when the refrigerator 100 determines that there is no user input for the at least one key mapped to the predefined operation, the refrigerator 100 may control the output interface 120 to maintain the notification about occurrence of the abnormal state of the refrigerator 100.

According to an embodiment of the disclosure, the plurality of keys included in the user interface 130 may include at least one key mapped to different operations in a normal mode and an abnormal mode. For example, the at least one key may be mapped to a predefined operation in the normal mode, and may be mapped to an operation of controlling a notification about occurrence of an abnormal state of the refrigerator 100 to be turned on or off in the abnormal mode. In an embodiment of the disclosure, according to whether the refrigerator 100 currently operates in the normal mode or the abnormal mode, the refrigerator 100 may differently operate, in response to the at least one key. For example, when the refrigerator 100 receives a user input via the at least one key, the refrigerator 100 may perform an operation of decreasing a temperature of a storage compartment in the normal mode, and may control the output interface 120 to control a notification about occurrence of an abnormal state to be turned off or on in the abnormal mode.

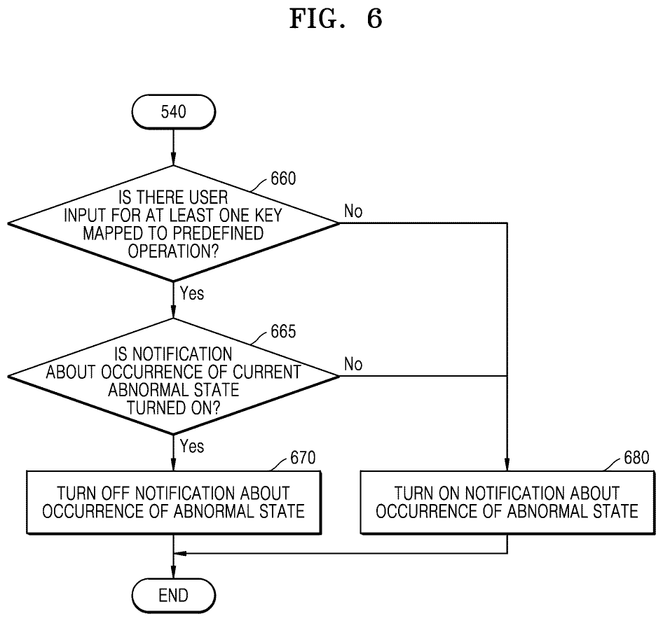

According to an embodiment of the disclosure, the at least one key mapped to different operations in the normal mode and the abnormal mode may be implemented as at least two keys. In this case, an operation of controlling a notification about occurrence of an abnormal state to be turned off or on may be implemented via the at least two keys. For example, the at least one key may include a first key for performing a predefined first operation and a second key for performing a predefined second operation in the normal mode. In the abnormal mode, the refrigerator 100 may turn off the notification about occurrence of the abnormal state via the first key, and may turn on the notification about occurrence of the abnormal state via the second key. For example, the first key may be a key for decreasing a temperature of a storage compartment, and the second key may be a key for increasing a temperature of the storage compartment. According to an embodiment of the disclosure, the at least one key mapped to different operations in the normal mode and the abnormal mode may be implemented as a single key, and this will be described with reference to FIG. 6.

According to an embodiment of the disclosure, the at least one key may be mapped to an operation of controlling a notification about occurrence of an abnormal state of the refrigerator 100 to be gradually turned off or on in the abnormal mode. According to an embodiment of the disclosure, when the refrigerator 100 receives a user input one time via the at least one key, the refrigerator 100 may decrease or increase a level of the notification about occurrence of the abnormal state. When the refrigerator 100 receives a user input a plurality of times via the at least one key, the refrigerator 100 may control the level of the notification about occurrence of the abnormal state to be gradually decreased and then turned off.

According to an embodiment of the disclosure, the plurality of keys may further include a general key mapped to the same operation in the normal mode and the abnormal mode. For example, the general key may be mapped to a predefined operation. According to an embodiment of the disclosure, when the refrigerator 100 receives a user input via the general key in the normal mode, the refrigerator 100 may perform the predefined operation. According to an embodiment of the disclosure, in a case where the refrigerator 100 operates in the abnormal mode due to a malfunction of the refrigerator 100, the refrigerator 100 may not perform an operation even when the refrigerator 100 receives a user input via the general key. Therefore, it is possible to prevent that the refrigerator 100 is randomly controlled by a user input when the refrigerator 100 has a malfunction, so that safety of a user may be ensured. When the refrigerator 100 has a malfunction, the refrigerator 100 may perform an operation of turning off or on a notification about occurrence of an abnormal state.

According to an embodiment of the disclosure, the refrigerator 100 may control the notification about occurrence of the abnormal state to be turned off by a user input even before the abnormal state of the refrigerator 100 is resolved. For example, the refrigerator 100 may control the sound output interface 121 to turn off the notification about occurrence of the abnormal state, by a user input, even before a malfunction of the refrigerator 100 is repaired. As the refrigerator 100 according to an embodiment of the disclosure turns off the notification about occurrence of the abnormal state, by a user input, inconvenience in which a user is exposed to auditory noise may be resolved.

When the refrigerator 100 according to an embodiment of the disclosure turns off the notification about occurrence of the abnormal state, the refrigerator 100 may transmit information indicating that the notification about occurrence of the abnormal state is turned off, to the service center via the device management server (see 300 of FIG. 16). Even when the notification is turned off by user control, the refrigerator 100 according to an embodiment of the disclosure may transmit the information to the service center so as to prevent repair of the abnormal state of the refrigerator 100 from being omitted.

FIG. 6 is a flowchart illustrating a method by which a refrigerator controls a notification about occurrence of an abnormal state via a single key, according to an embodiment of the disclosure.

Referring to FIG. 6, according to an embodiment of the disclosure, at least one key mapped to different operations in a normal mode and an abnormal mode may be implemented as the single key.

In operation 660, the refrigerator 100 according to an embodiment of the disclosure may identify whether there is a user input for the at least one key mapped to a predefined operation in the abnormal mode. Operation 660 may correspond to operation 560 of FIG. 5.

In operation 665, the refrigerator 100 according to an embodiment of the disclosure may identify whether a notification about occurrence of a current abnormal state is turned on. For example, the refrigerator 100 may identify whether the sound output interface 121 outputs a notification about occurrence of an abnormal state.

In operation 670, according to an embodiment of the disclosure, when the refrigerator 100 determines that the notification about occurrence of the current abnormal state is turned on, the refrigerator 100 may control the output interface 120 to turn off the notification about occurrence of the abnormal state. For example, when the refrigerator 100 determines that the sound output interface 121 outputs the notification about occurrence of the abnormal state, the refrigerator 100 may control the sound output interface 121 to turn off the notification, based on a user input for the at least one key.

In operation 670, according to an embodiment of the disclosure, when the refrigerator 100 determines that the notification about occurrence of the current abnormal state is turned off, the refrigerator 100 may control the output interface 120 to turn on again the notification about occurrence of the abnormal state. For example, when the refrigerator 100 determines that the sound output interface 121 does not output the notification about occurrence of the abnormal state, the refrigerator 100 may control the sound output interface 121 to turn on again the notification, based on a user input for the at least one key.

According to an embodiment of the disclosure, when an operation of controlling a notification about occurrence of an abnormal state to be turned off or on is implemented via the single key, the refrigerator 100 may identify whether the notification is currently turned on, based on a user input via the single key. When the refrigerator 100 determines that the notification is currently on, the refrigerator 100 may turn off the notification, based on a user input for the single key. When the refrigerator 100 determines that the notification is currently off, the refrigerator 100 may turn on the notification, based on a user input via the single key. For example, the single key may be a key for decreasing a temperature of a storage compartment in a normal mode, and may be a key for controlling a notification to be turned off or on in an abnormal mode.

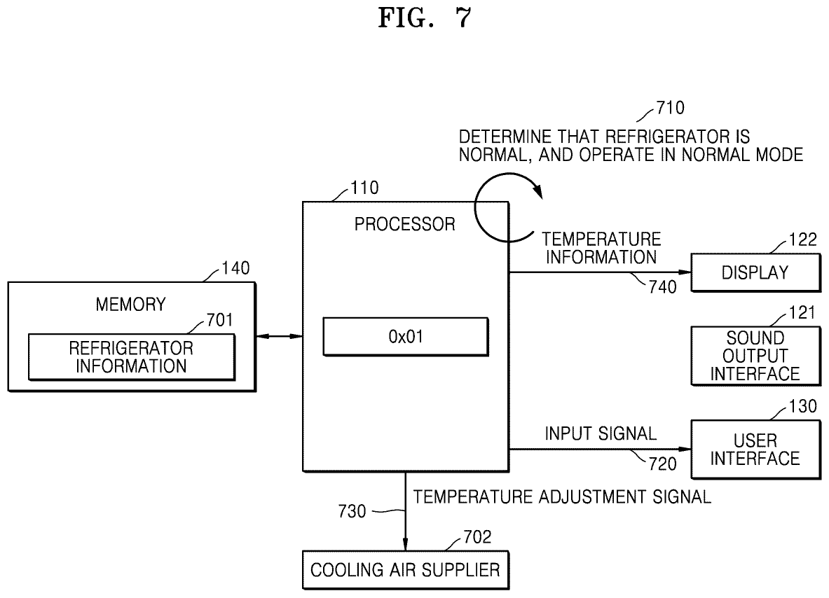

Hereinafter, with reference to FIGS. 7 to 9, an operation in which the refrigerator 100 controls a notification about occurrence of an abnormal state will now be described.

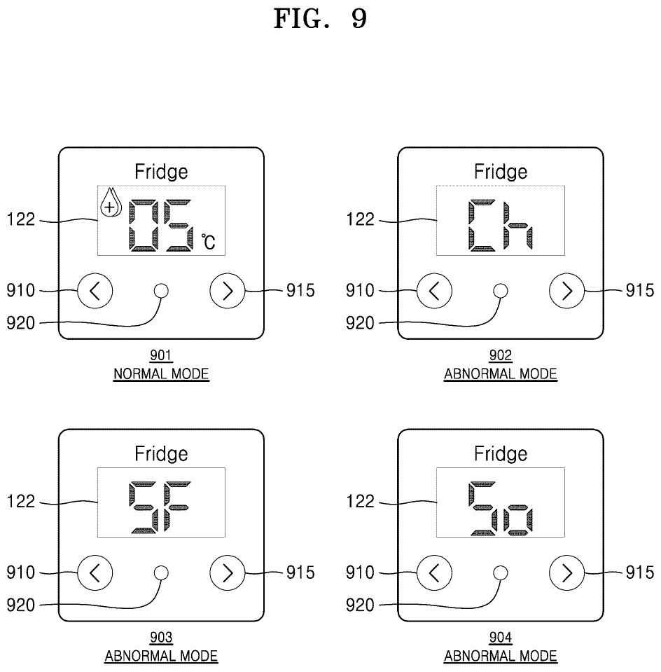

FIG. 7 is a diagram for describing an operation performed by a refrigerator in a normal state, according to an embodiment of the disclosure. FIG. 9 is a diagram of an example showing a display and a user interface of a refrigerator, according to an embodiment of the disclosure. FIG. 7 is a diagram for describing a normal mode of the refrigerator 100 according to operation 520, operation 530, operation 540, and operation 545 of FIG. 5. 901 of FIG. 9 is a diagram for describing a normal mode of the refrigerator 100.

Referring to FIG. 7, the processor 110 may identify refrigerator information 701 stored in the memory 140. The processor 110 may read the refrigerator information 701 stored in the memory 140, may identify a model of the refrigerator 100, and may set a program for driving the refrigerator 100. The refrigerator information 701 may indicate a value for identifying a refrigerator model. The refrigerator information 701 may be stored in the form of hexadecimal number such as 0x01, 0x02, . . . 0xFD, 0xFE in the memory 140 corresponding to an EEPROM.

The processor 110 may identify that the refrigerator information 701 is, for example, 0x01. The processor 110 may execute a program matched with the refrigerator model.

The processor 110 may read the refrigerator information 701 stored in the memory 140, and may identify whether there is an abnormal state in the refrigerator 100. When there is no abnormality in information about the refrigerator 100, the processor 110 may determine that the refrigerator 100 is normal. The processor 110 may determine that the refrigerator 100 is normal, and may operate in a normal mode (operation 710).

The processor 110 may receive a user input via at least one key of the user interface 130 in the normal mode (operation 720). The processor 110 may receive an input signal for the at least one key mapped to a predefined operation via the user interface 130. For example, in 901 of FIG. 9, the user interface 130 may include a left direction key 910. The left direction key 910 may be a key mapped to an operation of decreasing a temperature of a fridge compartment. The user interface 130 may include a right direction key 915. The right direction key 915 may be a key mapped to an operation of increasing a temperature of the fridge compartment. The user interface 130 may include a middle key 920. The middle key 920 may be a key mapped to a selection operation.

When the processor 110 receives the user input via the at least one key, the processor 110 may perform the predefined operation (operation 730). For example, in 901 of FIG. 9, when the processor 110 receives a user input via the left direction key 910, the processor 110 may control a cooling air supplier 702 to decrease a temperature of a storage compartment. The processor 110 may provide a temperature adjustment signal to the cooling air supplier 702. The cooling air supplier 702 of FIG. 7 may correspond to the cooling air supplier 1620 of FIG. 3.

The processor 110 may control the display 122 to display temperature information on the display 122 (operation 740). For example, the display 122 may display that a temperature of the fridge compartment is 5° C. Although not illustrated, the processor 110 may control the sound output interface 121 to output a notification about temperature adjustment.

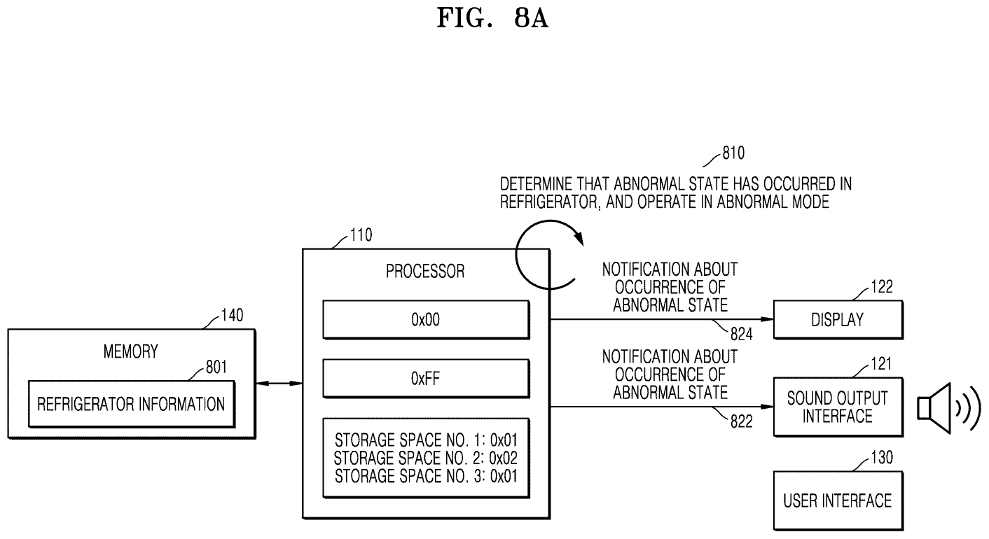

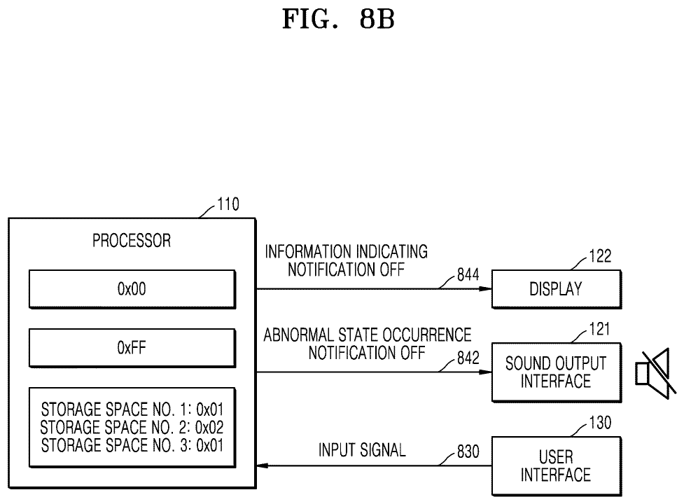

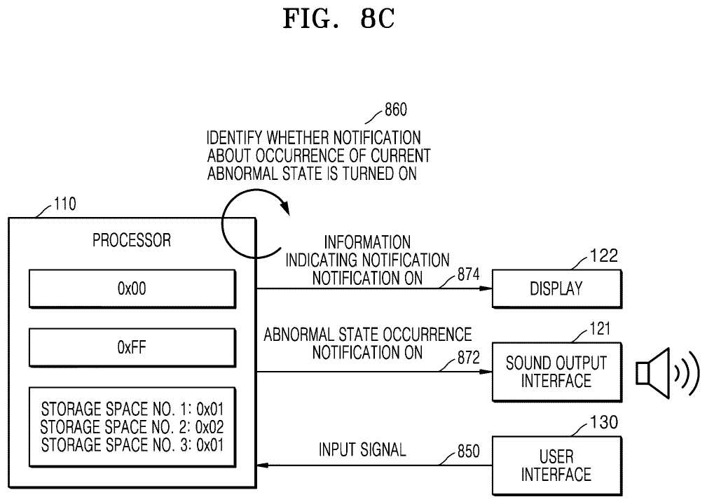

FIG. 8A is a diagram for describing an operation of outputting a notification when an abnormal state has occurred in a refrigerator, according to an embodiment of the disclosure. FIG. 9 is a diagram of an example indicating a display and a user interface of a refrigerator, according to an embodiment of the disclosure. FIG. 8A is a diagram for describing an abnormal mode of the refrigerator 100 according to operation 530 and operation 550 of FIG. 5. 902 of FIG. 9 is a diagram for describing the abnormal mode of the refrigerator 100.

When there is an abnormality in refrigerator information 801 stored in the memory 140, the processor 110 may identify that an abnormal state has occurred in the refrigerator 100. For example, the abnormal state in the refrigerator 100 may indicate a malfunction which needs to be repaired by a service engineer, the malfunction including a fridge compartment temperature sensor malfunction, a freezer compartment temperature sensor malfunction, a humidity sensor malfunction, a freezer compartment evaporator fan malfunction, an ice-maker malfunction, a refrigerator communication error, a cooling air supplier malfunction, or the like. For example, when there is an abnormality in the refrigerator information 801 stored in the memory 140, it may be assumed that the ‘Ch’ error exists.

When the refrigerator information 801 stored in the memory 140 is 0xFF that corresponds to first state information, the processor 110 may determine that there is an abnormality in the refrigerator information 801.

When the refrigerator information 801 stored in the memory 140 is 0x00 that corresponds to second state information, the processor 110 may determine that there is an abnormality in the refrigerator information 801.

The processor 110 may read the refrigerator information 801 from a plurality of storage spaces in the memory 140. When the processor 110 determines that the refrigerator information 801 identified from at least one storage space is different from the refrigerator information 801 identified from other storage spaces, the processor 110 may determine that there is an abnormality in the refrigerator information 801.

For example, the processor 110 may identify the refrigerator information 801 from three storage spaces. When the refrigerator information 801 identified from storage space no. 1 is 0x01, the refrigerator information 801 identified from storage space no. 3 is 0x01, and the refrigerator information 801 identified from storage space no. 2 is 0x02, the refrigerator 100 may determine that there is an abnormality in the refrigerator information 801.

When there is an abnormality in refrigerator information 801 stored in the memory 140, the processor 110 may identify that an abnormal state has occurred in the refrigerator 100. When the abnormal state has occurred in the refrigerator 100, the processor 110 may operate in the abnormal mode (operation 810).

In the abnormal mode, the processor 110 may output a notification about occurrence of the abnormal state of the refrigerator 100.

According to the abnormal mode, the processor 110 may control the sound output interface 121 to output the notification about occurrence of the abnormal state (operation 822).

According to the abnormal mode, the processor 110 may control the display 122 to display the notification about occurrence of the abnormal state (operation 824). For example, in 902 of FIG. 9, the processor 110 may display the ‘Ch’ error indicating the notification about occurrence of the abnormal state, on the display 122. For example, the ‘Ch’ error may be an error that cannot be resolved until the refrigerator 100 is repaired by a service engineer.

FIG. 8B is a diagram for describing an operation of turning off a notification output from a refrigerator, according to an embodiment of the disclosure. FIG. 9 is a diagram of an example indicating a display and a user interface of a refrigerator, according to an embodiment of the disclosure. FIG. 8B is a diagram for describing an operation of turning off a notification in an abnormal mode of the refrigerator 100 according to operation 560 and operation 570 of FIG. 5. 903 of FIG. 9 is a diagram for describing an operation of turning off a notification in an abnormal mode of the refrigerator 100.

The processor 110 may receive a user input via at least one key in the user interface 130 (operation 830). The processor 110 may receive an input signal for the at least one key mapped to a predefined operation via the user interface 130. The at least one key may be mapped to different operations in a normal mode and an abnormal mode. For example, the at least one key may be mapped to a predefined operation in the normal mode, and may be mapped to an operation of controlling a notification about occurrence of an abnormal state of the refrigerator 100 to be turned on or off in the abnormal mode. According to whether the processor 110 currently operates in the normal mode or the abnormal mode, the processor 110 may differently operate, in response to the at least one key.

For example, in 903 of FIG. 9, the processor 110 may receive an input signal for the left direction key 910. The left direction key 910 may be mapped to an operation of decreasing a temperature of a storage compartment in the normal mode, and may be mapped to an operation of controlling a notification about occurrence of an abnormal state to be turned on or off in the abnormal mode.

Based on the input for the at least one key, the processor 110 may control the sound output interface 121 to turn off the notification about occurrence of the abnormal state (operation 842). The sound output interface 121 may not output the notification about occurrence of the abnormal state, based on the user input. The processor 110 may control the display 122 to display information indicating that the notification about occurrence of the abnormal state is turned off, based on the input for the at least one key (operation 844). For example, in 903 of FIG. 9, the processor 110 may display, on the display 122, ‘SF (Sound Off)’ indicating the information indicating that the notification about occurrence of the abnormal state is turned off.

The processor 110 may receive a user input for a general key mapped to the same operation in the normal mode and the abnormal mode. For example, the processor 110 may receive a user input via the right direction key 915 or the middle key 920 of FIG. 9. When there is the ‘Ch’ error that cannot be resolved until the refrigerator 100 is repaired by a service engineer, the processor 110 may not operate even when an input for the general key is received.

FIG. 8C is a diagram for describing an operation of turning on a notification output from a refrigerator, according to an embodiment of the disclosure. FIG. 9 is a diagram of an example indicating a display and a user interface of a refrigerator, according to an embodiment of the disclosure. FIG. 8C is a diagram for describing an operation of turning on a notification in an abnormal mode of the refrigerator 100 according to operation 560 and operation 580 of FIG. 5. 904 of FIG. 9 is a diagram for describing an operation of turning on a notification in an abnormal mode of the refrigerator 100.

The processor 110 may receive a user input via at least one key in the user interface 130 (operation 850). The processor 110 may receive an input signal via the at least one key mapped to a predefined operation in the user interface 130. For example, an input signal in operation 850 may be a follow-up signal of an input signal in operation 830 of FIG. 8B.

For example, in 904 of FIG. 9, the processor 110 may receive an input signal via the left direction key 910. The left direction key 910 may be mapped to an operation of decreasing a temperature of a storage compartment in the normal mode, and may be mapped to an operation of controlling a notification about occurrence of an abnormal state to be turned on or off in the abnormal mode.

The processor 110 may identify whether a notification about occurrence of a current abnormal state is turned on, based on the input for the at least one key (operation 860). The processor 110 may identify whether the sound output interface 121 outputs a notification about occurrence of an abnormal state. Operation 860 may correspond to operation 665 of FIG. 6.

For example, when the processor 110 determines that the notification about occurrence of the current abnormal state is turned off, the processor 110 may control the sound output interface 121 to turn on again the notification about occurrence of the abnormal state, based on the input via the at least one key (operation 872). The sound output interface 121 may output again the notification about occurrence of the abnormal state. The processor 110 may control the display 122 to display information indicating that the notification about occurrence of the abnormal state is turned on (operation 874). For example, in 904 of FIG. 9, the processor 110 may display, on the display 122, ‘So (Sound On)’ indicating the information indicating that the notification about occurrence of the abnormal state is turned on.

Unlike to this, when the processor 110 determines that the notification about occurrence of the current abnormal state is turned on, the processor 110 may control the sound output interface 121 to turn off the notification about occurrence of the abnormal state.

Unlike to the examples of FIGS. 8A to 8C, the processor 110 according to an embodiment of the disclosure may omit an operation of identifying whether the notification about occurrence of the current abnormal state is turned on. For example, when the at least one key mapped to different operations in the normal mode and the abnormal mode is implemented as at least two keys, the processor 110 may omit the operation of identifying whether the notification about occurrence of the current abnormal state is turned on. For example, the left direction key 910 may be mapped to an operation of decreasing a temperature of a fridge compartment in the normal mode, and may be mapped to an operation of turning off a notification about occurrence of an abnormal state in the abnormal mode. Also, the right direction key 915 may be mapped to an operation of increasing a temperature of the fridge compartment in the normal mode, and may be mapped to an operation of turning on a notification about occurrence of an abnormal state in the abnormal mode. In this case, based on a user input via the left direction key 910, the processor 110 may turn off the notification about occurrence of the abnormal state. Based on a user input via the right direction key 915, the processor 110 may turn on the notification about occurrence of the abnormal state.

FIG. 10 is a flowchart of a method by which a refrigerator controls a notification about occurrence of an abnormal state, according to an embodiment of the disclosure.

Referring to FIG. 10, in operation 1010, the refrigerator 100 according to an embodiment of the disclosure may identify whether the door 1630 is open during a preset time or longer. The refrigerator 100 may detect an open/closed state of the door 1630 via the door switch 1640. The door switch 1640 may include a reed switch configured to detect an open/closed state of the door 1630 by using a magnet. For example, the open/closed state of the door 1630 may be detected in a manner that, when the door 1630 is open, the door switch 1640 is electrically connected, and, when the door 1630 is closed, the door switch 1640 is open. For example, the door switch 1640 may provide a detection signal about a door open state to the processor 110. When the processor 110 receives the detection signal during a preset time or longer from the door switch 1640, the processor 110 may determine that the door 1630 is open during the preset time or longer. For example, the preset time may be two minutes, but the disclosure is not limited thereto.

Alternatively, when there is an open malfunction in the door switch 1640, the refrigerator 100 may incorrectly determine that the door 1630 is open even when the door 1630 is closed. For example, even when the door 1630 is closed, the door switch 1640 may provide a detection signal about a door open state to the processor 110. When the processor 110 receives the detection signal during a preset time or longer from the door switch 1640, the processor 110 may determine that the door 1630 is open during the preset time or longer.

In operation 1010 and operation 1020, when the door 1630 is not open during the preset time or longer, the refrigerator 100 according to an embodiment of the disclosure may determine that the refrigerator 100 is normal. The refrigerator 100 may operate in a normal mode.

In operation 1030, according to a user input for at least one key mapped to a predefined operation in the normal mode, the refrigerator 100 according to an embodiment of the disclosure may perform the predefined operation.

According to an embodiment of the disclosure, the user interface 130 may include a plurality of keys. Each of the plurality of keys may be configured as a form of one of a button for receiving a push operation of a user, a touch pad for detecting a user touch, a jog wheel, a jog switch, and a dome switch. A user may control various functions of the refrigerator 100 by using the plurality of keys arranged in the user interface 130. For example, the plurality of keys may be associated with or mapped to predefined operations. For example, the predefined operations may include storage compartment temperature adjustment, menu selection, starting of an ice-making operation, stopping of the ice-making operation, starting of water extraction from a water purifier, or the like.

According to an embodiment of the disclosure, the memory 140 may store information about the predefined operations corresponding to the plurality of keys. For example, the memory 140 may store information about the predefined operations mapped to the plurality of keys. For example, when at least one key among the plurality of keys is actuated by a user, the processor 110 may perform a predefined operation mapped to the at least one key. For example, when the processor 110 receives a user input via a key mapped to an operation of decreasing a temperature of a storage compartment, the processor 110 may control a cooling air supplier to decrease the temperature of the storage compartment.

In operation 1010 and operation 1040, when the door 1630 is open during the preset time or longer, the refrigerator 100 according to an embodiment of the disclosure may determine that an abnormal state has occurred in the refrigerator 100. When the door 1630 is open during the preset time or longer, the refrigerator 100 may operate in an abnormal mode. For example, when the door 1630 is open during the preset time or longer, an internal temperature of the refrigerator 100 is changed due to an outside temperature, and thus, the refrigerator 100 may provide a notification for a user to recognize an abnormal state due to the door being open. For example, the refrigerator 100 may output a notification about occurrence of the abnormal state. For example, the refrigerator 100 may control the display 122 to display the notification about occurrence of the abnormal state, according to the abnormal mode. Also, for example, the refrigerator 100 may control the sound output interface 121 to output the notification about occurrence of the abnormal state, according to the abnormal mode.

The abnormal state due to door being open may be resolved when the door 1630 is closed. The refrigerator 100 may output the notification about occurrence of the abnormal state until the door 1630 is closed. Unlike to this, the abnormal state due to a malfunction of the door switch 1640 may be an error that cannot be resolved until the door switch 1640 is repaired by a service engineer. The refrigerator 100 may output the notification about occurrence of the abnormal state even when the door 1630 is closed.

In operation 1050, the refrigerator 100 according to an embodiment of the disclosure may identify whether there is a user input via at least one key mapped to a predefined operation in the abnormal mode.

In operation 1060, according to an embodiment of the disclosure, when the refrigerator 100 determines that there is the user input via the at least one key mapped to the predefined operation, the refrigerator 100 may control the output interface 120 to turn off the notification about occurrence of the abnormal state of the refrigerator 100.

In operation 1070, according to an embodiment of the disclosure, when the refrigerator 100 determines that there is no user input via the at least one key mapped to the predefined operation, the refrigerator 100 may control the output interface 120 to maintain the notification about occurrence of the abnormal state of the refrigerator 100.

According to an embodiment of the disclosure, the plurality of keys included in the user interface 130 may include at least one key mapped to different operations in a normal mode and an abnormal mode. For example, the at least one key may be mapped to a predefined operation in the normal mode, and may be mapped to an operation of controlling a notification about occurrence of an abnormal state of the refrigerator 100 to be turned on or off in the abnormal mode. In an embodiment of the disclosure, according to whether the refrigerator 100 currently operates in the normal mode or the abnormal mode, the refrigerator 100 may differently operate, in response to the at least one key. For example, when the refrigerator 100 receives a user input via the at least one key, the refrigerator 100 may perform an operation of decreasing a temperature of a storage compartment in the normal mode, and may control the output interface 120 to control a notification about occurrence of an abnormal state to be turned off or on in the abnormal mode.

According to an embodiment of the disclosure, the at least one key mapped to different operations in the normal mode and the abnormal mode may be implemented as at least two keys. In this case, an operation of controlling a notification about occurrence of an abnormal state to be turned off or on may be implemented via the at least two keys. For example, the at least one key may include a first key for performing a predefined first operation and a second key for performing a predefined second operation in the normal mode. In the abnormal mode, the refrigerator 100 may turn off the notification about occurrence of the abnormal state via the first key, and may turn on the notification about occurrence of the abnormal state via the second key. For example, the first key may be a key for decreasing a temperature of a storage compartment, and the second key may be a key for increasing a temperature of the storage compartment. According to an embodiment of the disclosure, the at least one key mapped to different operations in the normal mode and the abnormal mode may be implemented as a single key, and as this is described with reference to FIG. 6, detailed descriptions thereof are not provided there.

According to an embodiment of the disclosure, the plurality of keys may further include a general key mapped to the same operation in the normal mode and the abnormal mode. For example, the general key may be mapped to a predefined operation. According to an embodiment of the disclosure, when the refrigerator 100 receives a user input via the general key in the normal mode, the refrigerator 100 may perform the predefined operation. In an embodiment of the disclosure, in a case where the refrigerator 100 operates in the abnormal mode due to the door being open, when the refrigerator 100 receives a user input via the general key, the refrigerator 100 may perform a predefined operation. In the abnormal state due to the door being open, a user may control various functions of the refrigerator 100 by using the general key. This is different from a case of FIG. 5 in which, in the abnormal state due to a malfunction in the refrigerator 100, even when a user inputs the general key, the refrigerator 100 does not perform the predefined operation.

According to an embodiment of the disclosure, the refrigerator 100 may control the notification about occurrence of the abnormal state to be turned off by a user input even before the abnormal state of the refrigerator 100 is resolved. For example, even before the door 1630 is closed, the refrigerator 100 may control the sound output interface 121 to turn off the notification about occurrence of the abnormal state, by a user input. For example, even before a malfunction of the door switch 1640 is repaired, the refrigerator 100 may control the sound output interface 121 to turn off the notification about occurrence of the abnormal state, by a user input. As the refrigerator 100 according to an embodiment of the disclosure turns off the notification about occurrence of the abnormal state, by a user input, inconvenience in which a user is exposed to auditory noise may be resolved.

When the refrigerator 100 according to an embodiment of the disclosure turns off the notification about occurrence of the abnormal state, the refrigerator 100 may transmit information indicating that the notification about occurrence of the abnormal state is turned off, to a service center via a device management server (see 300 of FIG. 16). Even when the notification is turned off by user control, the refrigerator 100 according to an embodiment of the disclosure may transmit the information to the service center so as to prevent repair of the abnormal state of the refrigerator 100 from being omitted.

FIG. 11A is a diagram for describing an operation of outputting a notification when an abnormal state has occurred in a refrigerator, according to an embodiment of the disclosure. FIG. 11A is a diagram for describing an abnormal mode of the refrigerator 100 according to operation 1010 and operation 1040 of FIG. 10.

The processor 110 may detect an open/closed state of the door 1630 by the door switch 1640. The door switch 1640 may include a reed switch configured to detect an open/closed state of the door 1630 by using a magnet. For example, the open/closed state of the door 1630 may be detected in a manner that, when the door 1630 is open, the door switch 1640 is electrically connected, and, when the door 1630 is closed, the door switch 1640 is open. The door switch 1640 may provide a detection signal about an open/closed state of the door 1630 to the processor 110.

The processor 110 may identify whether the door 1630 is open during a preset time or longer (operation 1110). For example, when the door 1630 is open, the door switch 1640 may provide the detection signal about a door open state to the processor 110. The processor 110 may receive the detection signal about an open state of the door 1630 from the door switch 1640. When the processor 110 receives the detection signal during a preset time or longer from the door switch 1640, the processor 110 may determine that the door 1630 is open during the preset time or longer. For example, the preset time may be two minutes, but the disclosure is not limited thereto.

Alternatively, when there is an open malfunction in the door switch 1640, even when the door 1630 is closed, the door switch 1640 may provide a detection signal about a door open state to the processor 110 (operation 1110). The processor 110 may incorrectly determine that the door 1630 is open even when the door 1630 is closed. When the processor 110 receives the detection signal during a preset time or longer from the door switch 1640, the processor 110 may determine that the door 1630 is open during the preset time or longer.

When the door 1630 is open during the preset time or longer, the processor 110 may determine that an abnormal state has occurred in the refrigerator 100. Accordingly, the processor 110 may operate in an abnormal mode (operation 1120). For example, when the door 1630 is open during the preset time or longer, an internal temperature of the refrigerator 100 is changed due to an outside temperature, and thus, the processor 110 may provide a notification for a user to recognize an abnormal state due to door open.

For example, the processor 110 may control the sound output interface 121 to output the notification about occurrence of the abnormal state, according to the abnormal mode (operation 1130).

The abnormal state due to the door being open may be resolved when the door 1630 is closed. The refrigerator 100 may output the notification about occurrence of the abnormal state until the door 1630 is closed. Unlike to this, the abnormal state due to a malfunction of the door switch 1640 may be an error that cannot be resolved until the door switch 1640 is repaired by a service engineer. The refrigerator 100 may output the notification about occurrence of the abnormal state even when the door 1630 is closed.

Alternatively, although not illustrated, the processor 110 may control the display 122 to display the notification about occurrence of the abnormal state.

FIG. 11B is a diagram for describing an operation of turning off a notification output from a refrigerator, according to an embodiment of the disclosure. FIG. 11B is a diagram for describing an operation of turning off a notification in an abnormal mode of the refrigerator 100 according to operation 1050 and operation 1060 of FIG. 10.

The processor 110 may receive a user input via at least one key in the user interface 130 (operation 1140). The processor 110 may receive an input signal via the at least one key mapped to a predefined operation via the user interface 130. The at least one key may be mapped to different operations in a normal mode and an abnormal mode. For example, the at least one key may be mapped to a predefined operation in the normal mode, and may be mapped to an operation of controlling a notification about occurrence of an abnormal state of the refrigerator 100 to be turned on or off in the abnormal mode. According to whether the processor 110 currently operates in the normal mode or the abnormal mode, the processor 110 may differently operate, in response to the at least one key being actuated. For example, when the processor 110 receives a user input via at least one key in the normal mode, the processor 110 may perform a predefined operation mapped to the at least one key. For example, when the processor 110 receives a user input via the at least one key in the abnormal mode, the processor 110 may control the notification about occurrence of the abnormal state to be turned off or on.

For example, as in 903 of FIG. 9, the processor 110 may receive an input signal via the left direction key 910. The left direction key 910 may be mapped to an operation of decreasing a temperature of a storage compartment in the normal mode, and may be mapped to an operation of controlling a notification about occurrence of an abnormal state to be turned on or off in the abnormal mode.

Based on the input for the at least one key, the processor 110 may control the sound output interface 121 to turn off the notification about occurrence of the abnormal state (operation 1152). The sound output interface 121 may not output the notification about occurrence of the abnormal state, based on the user input. The processor 110 may control the display 122 to display information indicating that the notification about occurrence of the abnormal state is turned off, based on the input via the at least one key (operation 1154). For example, the processor 110 may display, on the display 122, ‘SF (Sound Off)’ indicating the information indicating that the notification about occurrence of the abnormal state is turned off.

The processor 110 may receive a user input via a general key mapped to the same operation in the normal mode and the abnormal mode. For example, the processor 110 may receive a user input via the right direction key 915 or the middle key 920 of FIG. 9. In a case where the refrigerator 100 operates in the abnormal mode due to the door being open, when the processor 110 receives a user input via the general key, the refrigerator 100 may perform a predefined operation. In the abnormal state due to the door being open, a user may control various functions of the refrigerator 100 by using the general key. This is different from a case of FIG. 5 in which, in the abnormal state due to a malfunction in the refrigerator 100, even when a user inputs the general key, the refrigerator 100 does not perform the predefined operation.

FIG. 12 is a flowchart illustrating a method by which a refrigerator controls a notification about occurrence of an abnormal state, according to an embodiment of the disclosure.

Referring to FIG. 12, in operation 1210, the refrigerator 100 according to an embodiment of the disclosure may identify whether the refrigerator is in an abnormal state. According to an embodiment of the disclosure, determining whether a refrigerator is in an abnormal state may correspond to determining whether an abnormal state of the refrigerator has occurred. According to an embodiment of the disclosure, the abnormal state of the refrigerator 100 may include a malfunction state of the refrigerator 100 based on occurrence of an abnormality in information about the refrigerator 100, a state in which the door 1630 of the refrigerator 100 is open during a preset time or longer, a malfunction state in the door switch 1640 of the refrigerator 100, or the like. Operation 1210 may correspond to operation 410 of FIG. 4.

In operation 1220, the refrigerator 100 according to an embodiment of the disclosure may operate in an abnormal mode, based on identifying the refrigerator 100 as being in an abnormal state. The refrigerator 100 may control the output interface 120 to output a notification about occurrence of the abnormal state in the refrigerator 100. For example, the refrigerator 100 may control the sound output interface 121 to output the notification about occurrence of the abnormal state, according to the abnormal mode. For example, the refrigerator 100 may control the display 122 to display the notification about occurrence of the abnormal state, according to the abnormal mode. Operation 1220 may correspond to operation 420 of FIG. 4.

In operation 1230, the refrigerator 100 according to an embodiment of the disclosure may output information indicating that a dummy key that is not mapped to a predefined operation is able to control a notification about occurrence of an abnormal state of the refrigerator 100. For example, the refrigerator 100 may control the display 122 to output the information indicating that the dummy key is able to control the notification about occurrence of the abnormal state of the refrigerator 100.

According to an embodiment of the disclosure, the user interface 130 may include a plurality of keys. Each of the plurality of keys may be formed as one of the button for receiving a push operation of a user, the touch pad for detecting a user's touch, the jog wheel, the jog switch, and the dome switch. A user may control various functions of the refrigerator 100 by using the plurality of keys provided at the user interface 130. For example, the plurality of keys may be associated with or mapped to predefined operations. For example, the predefined operations may include storage compartment temperature adjustment, menu selection, starting of an ice-making operation, stopping of the ice-making operation, starting of water extraction from a water purifier, or the like.

According to an embodiment of the disclosure, the user interface 130 may include a dummy key that is not associated with or mapped to a preset operation performed when the refrigerator 100 is in a normal state. For example, the dummy key may include a touch sensor but there is no operation mapped to the dummy key. Even when the refrigerator 100 receives a user input via the dummy key, the refrigerator 100 does not perform a preset operation, or a predefined operation in the normal mode.

According to an embodiment of the disclosure, the dummy key may be mapped to different operations in a normal mode and an abnormal mode. For example, the dummy key is not a key for controlling a predefined operation in the normal mode, but may be used as a key for controlling a notification to be turned off or on in the abnormal mode. For example, the dummy key may not be mapped to a predefined operation in the normal mode, and may be mapped to an operation of controlling a notification about occurrence of an abnormal state of the refrigerator 100 to be turned on or off in the abnormal mode.

In the normal mode according to an embodiment of the disclosure, the dummy key does not have an indication for guiding a user for a preset function, and thus, the user does not control the predefined operation for the refrigerator 100 by using the dummy key.

In the abnormal mode according to an embodiment of the disclosure, the refrigerator 100 may provide the user with a guidance guiding that a notification can be controlled by using the dummy key in the abnormal state of the refrigerator 100. As the dummy key does not have the indication for guiding the user for a preset function, the refrigerator 100 may guide the user that the user can control a preset operation by using the dummy key. For example, the refrigerator 100 may display information indicating that the dummy key is able to control a notification about occurrence of an abnormal state of the refrigerator 100. For example, the refrigerator 100 may display information indicating that an input via the dummy key has to be maintained for several seconds to control the notification of the refrigerator 100. For example, the refrigerator 100 may display an indication informing a position of the dummy key. For example, the refrigerator 100 may display an arrow around the dummy key which informs the position of the dummy key, information indicating that the dummy key is able to turn off or on a notification about occurrence of an abnormal state, and information indicating that an input via the dummy key has to be maintained for five seconds.

In operation 1240, the refrigerator 100 according to an embodiment of the disclosure may control the output interface 120 to turn off the notification about occurrence of the abnormal state of the refrigerator 100, based on a user input via the dummy key while the refrigerator 100 is identified as being in the abnormal state. For example, the refrigerator 100 may control the sound output interface 121 to turn off the notification about occurrence of the abnormal state of the refrigerator 100, according to the user input via the dummy key. The sound output interface 121 may not output the notification about occurrence of the abnormal state of the refrigerator 100.

According to an embodiment of the disclosure, the refrigerator 100 may differently operate, in response to the dummy key, according to whether the refrigerator 100 currently operates in the normal mode or the abnormal mode. For example, when the refrigerator 100 in the normal mode receives a user input via the dummy key, the refrigerator 100 may not perform the preset operation. When the refrigerator 100 in the abnormal mode receives the user input via the dummy key, the refrigerator 100 may control the sound output interface 121 to control the notification about occurrence of the abnormal state to be turned off or on.

According to an embodiment of the disclosure, the refrigerator 100 may control a notification in the abnormal mode by using the dummy key not being used in the normal mode.

According to an embodiment of the disclosure, the refrigerator 100 may control the notification about occurrence of the abnormal state to be turned off by a user input even before the abnormal state of the refrigerator 100 is resolved. For example, the refrigerator 100 may control the sound output interface 121 to turn off the notification about occurrence of the abnormal state, by a user input, even before a malfunction of the refrigerator 100 is repaired. For example, even before the door 1630 is closed, the refrigerator 100 may control the sound output interface 121 to turn off the notification about occurrence of the abnormal state, by a user input. For example, even before a malfunction of the door switch 1640 is repaired, the refrigerator 100 may control the sound output interface 121 to turn off the notification about occurrence of the abnormal state, by a user input. As the refrigerator 100 according to an embodiment of the disclosure turns off the notification about occurrence of the abnormal state, by a user input, inconvenience in which a user is exposed to auditory noise may be resolved.

When the refrigerator 100 according to an embodiment of the disclosure turns off the notification about occurrence of the abnormal state, the refrigerator 100 may transmit information indicating that the notification about occurrence of the abnormal state is turned off, to a service center via a device management server (see 300 of FIG. 16). Even when the notification is turned off by user control, the refrigerator 100 according to an embodiment of the disclosure may transmit the information to the service center so as to prevent repair of the abnormal state of the refrigerator 100 from being omitted.

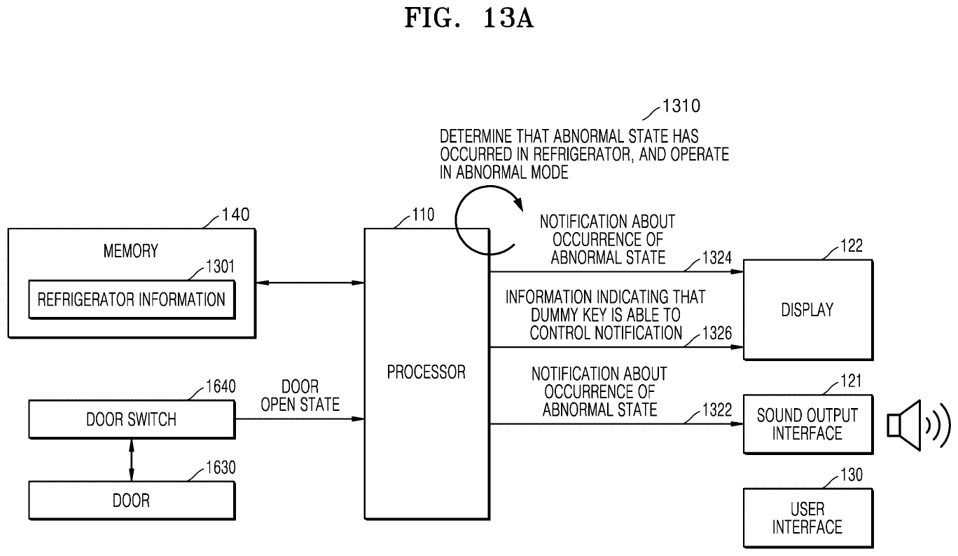

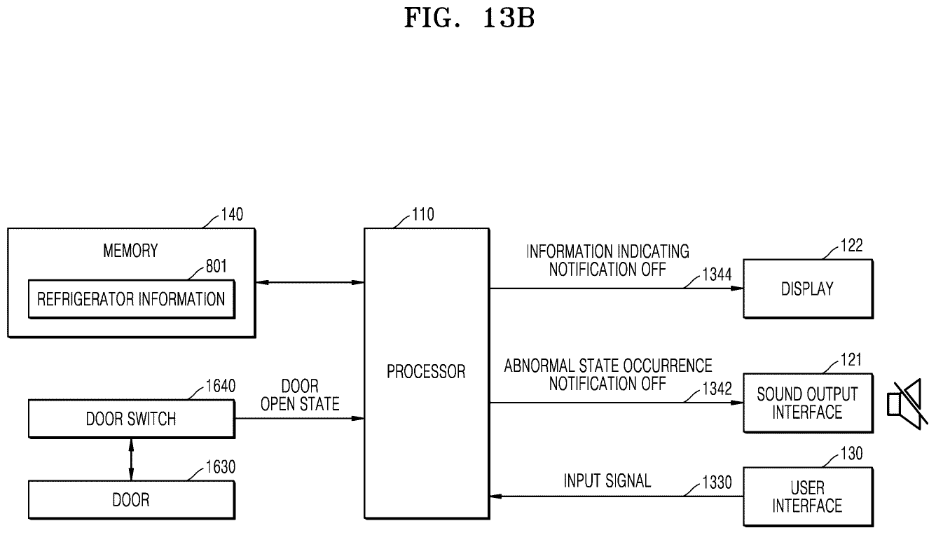

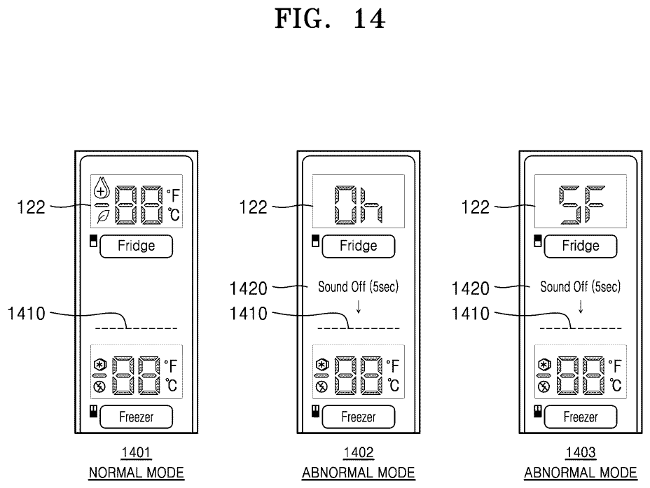

FIG. 13A is a diagram for describing an operation in which a refrigerator outputs a notification when an abnormal state has occurred in the refrigerator, and displays information indicating that the notification is able to be controlled, according to an embodiment of the disclosure. FIG. 14 is a diagram for describing an operation in which a refrigerator displays information indicating that a notification is able to be controlled, according to an embodiment of the disclosure. FIG. 13A is a diagram for describing an abnormal mode of the refrigerator 100 according to operation 1210, operation 1220, and operation 1230 of FIGS. 12. 1401 and 1402 of FIG. 14 respectively show a normal mode and an abnormal mode of the refrigerator 100.

The processor 110 may identify whether an abnormal state has occurred in the refrigerator 100.

When there is an abnormality in refrigerator information 1301 stored in the memory 140, the processor 110 may identify that the abnormal state has occurred in the refrigerator 100. For example, when the refrigerator information 1301 stored in the memory 140 is 0xFF corresponding to first state information or 0x00 corresponding to second state information, the processor 110 may determine that there is an abnormality in the refrigerator information 1301. For example, when the processor 110 determines that the refrigerator information 1301 identified from at least one storage space is different from the refrigerator information 1301 identified from other storage spaces, the processor 110 may determine that there is an abnormality in the refrigerator information 1301.

For example, when the door 1630 is open during a preset time or longer, the processor 110 may identify that there is an abnormal state in the refrigerator 100. For example, when the door 1630 is open, the door switch 1640 may provide the detection signal about a door open state to the processor 110. The processor 110 may receive the detection signal about an open state of the door 1630 from the door switch 1640. When the processor 110 receives the detection signal during a preset time or longer from the door switch 1640, the processor 110 may determine that the door 1630 is open during the preset time or longer.

For example, when there is an open malfunction in the door switch 1640, even when the door 1630 is closed, the door switch 1640 may provide a detection signal about a door open state to the processor 110. The processor 110 may incorrectly determine that the door 1630 is open even when the door 1630 is closed.

When the processor 110 determines that the abnormal state occurred in the refrigerator 100, the processor 110 may operate in the abnormal mode (operation 1310).

For example, the processor 110 may control the sound output interface 121 to output a notification about occurrence of the abnormal state, according to the abnormal mode (operation 1322). The sound output interface 121 may output a notification about occurrence of the abnormal state.

For example, the processor 110 may control the display 122 to display the notification about occurrence of the abnormal state, according to the abnormal mode (operation 1324). The display 122 may display the notification about occurrence of the abnormal state.

For example, the processor 110 may output information indicating that a dummy key that is not mapped to a predefined operation is able to control a notification about occurrence of an abnormal state of the refrigerator 100 (operation 1326).

For example, in 1401 of FIG. 14, a dummy key 1410 is not a key for controlling a predefined operation in the normal mode, but, in the abnormal mode, the dummy key 1410 may be used as a key for controlling a notification to be turned off or on. In the normal mode, the dummy key 1410 does not have an indication for guiding a user for a preset function, and thus, the user does not control the predefined operation for the refrigerator 100 by using the dummy key 1410.

For example, in 1402 of FIG. 14, the dummy key 1410 may be used as a key for controlling a notification to be turned off or on in the abnormal mode. The refrigerator 100 may provide the user with information 1420 indicating that a notification is able to be controlled by using the dummy key 1410 in the abnormal state of the refrigerator 100. As the dummy key 1410 does not have the indication for guiding the user for a preset function, the refrigerator 100 may guide the user that the user can control a preset operation by using the dummy key 1410. For example, the refrigerator 100 may display the information 1420 includes at least one of a down-direction arrow for informing a position of the dummy key 1410, a “Sound Off” indication indicating that the dummy key 1410 is able to turn off a notification about abnormal state occurrence, or information indicating that an input for the dummy key 1410 has to be maintained for five seconds.

For example, in 1402 of FIG. 14, the display 122 displays the ‘Ch’ error due to a malfunction of the refrigerator 100, but the disclosure is not limited thereto, and the display 122 may display door open or a door switch malfunction.

FIG. 13B is a diagram for describing an operation of turning off a notification output from a refrigerator, according to an embodiment of the disclosure. FIG. 14 is a diagram for describing an operation in which a refrigerator displays information indicating that a notification is able to be controlled, according to an embodiment of the disclosure. FIG. 13B is a diagram for describing an operation of turning off a notification in an abnormal mode of the refrigerator 100 according to operation 1240 of FIG. 12. 1403 of FIG. 14 is a diagram for describing an operation of turning off a notification in an abnormal mode of the refrigerator 100.

The processor 110 may receive a user input for a dummy key via the user interface 130 (operation 1330). A user may maintain the input for the dummy key for several seconds. For example, as shown in 1403 of FIG. 14, the processor 110 may receive an input signal for the dummy key 1410. The dummy key 1410 may not be mapped to a preset operation in a normal mode, and may be mapped to an operation of controlling a notification about occurrence of an abnormal state to be turned off or on in an abnormal state.

The processor 110 may differently operate, in response to the dummy key, according to whether the refrigerator 100 currently operates in the normal mode or the abnormal mode. For example, when the processor 110 in the normal mode receives a user input via the dummy key, the refrigerator 100 may not perform the preset operation. When the processor 110 in the abnormal mode receives the user input via the dummy key, the processor 110 may control the sound output interface 121 to turn off the notification about occurrence of the abnormal state (operation 1342). The sound output interface 121 may not output the notification about occurrence of the abnormal state. When the processor 110 receives a user input via the dummy key in the abnormal mode, the processor 110 may control the display 122 to display information indicating that the notification about occurrence of the abnormal state is turned off (operation 1344). For example, the processor 110 may display, on the display 122, ‘SF (Sound Off)’ indicating the information indicating that the notification about occurrence of the abnormal state is turned off.

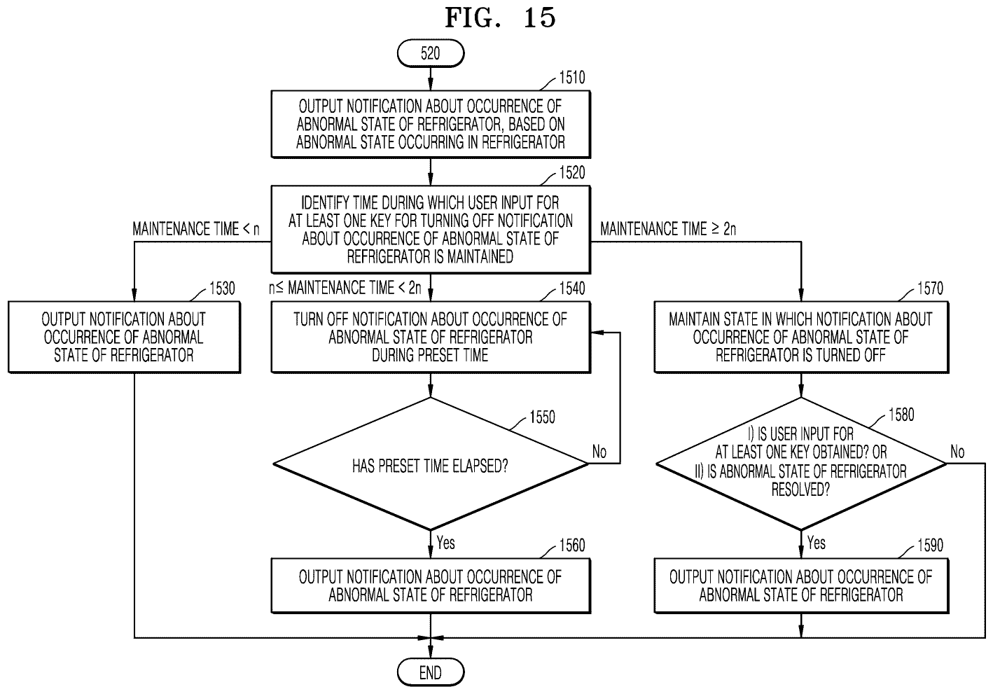

FIG. 15 is a flowchart illustrating a method by which a refrigerator controls a notification, according to a time during which an input for a key for controlling the notification is maintained, according to an embodiment of the disclosure.

Referring to FIG. 15, in operation 1510, the refrigerator 100 according to an embodiment of the disclosure may output a notification about occurrence of an abnormal state of the refrigerator 100, based on the abnormal state occurring in the refrigerator 100.

In operation 1520, the refrigerator 100 according to an embodiment of the disclosure may identify a time during which a user input for at least one key for turning off the notification about occurrence of the abnormal state of the refrigerator 100 is maintained. The at least one key may be mapped to the predefined operation in a normal mode, and may be mapped to an operation of controlling the notification about occurrence of the abnormal state of the refrigerator 100 in an abnormal mode. Based on a user input for the at least one key in the abnormal mode, the refrigerator 100 may control the sound output interface 121 to turn off the notification about occurrence of the abnormal state. The refrigerator 100 may identify a time during which the user input for the at least one key is maintained, and may differently perform an operation of controlling a notification, according to the time during which the user input is maintained.

In operation 1530, when the refrigerator 100 according to an embodiment of the disclosure determines that a time during which the user input for the at least one key is maintained is less than n seconds, the refrigerator 100 may output the notification about occurrence of the abnormal state of the refrigerator 100 (where n is a positive number). When the refrigerator 100 determines that the time during which the user input for the at least one key is maintained is less than n seconds, the refrigerator 100 may determine there is no user input for the at least one key. The refrigerator 100 may not control the sound output interface 121 to turn off the notification about occurrence of the abnormal state. Therefore, the refrigerator 100 may continuously output the notification about occurrence of the abnormal state.

In operation 1540, when the refrigerator 100 according to an embodiment of the disclosure determines that the time during which the user input for the at least one key is maintained is less than 2n seconds, refrigerator 100 may control the sound output interface 121 to turn off the notification about occurrence of the abnormal state of the refrigerator 100 during a preset time. The refrigerator 100 may determine that the time during which the user input for the at least one key is maintained is equal to or greater than n seconds and less than 2n seconds. For example, the preset time may be 30 minutes, but the disclosure is not limited thereto.

In operation 1550, the refrigerator 100 according to an embodiment of the disclosure may identify whether the preset time has elapsed. When the preset time has not elapsed, the refrigerator 100 may control the sound output interface 121 to turn off the notification within a preset time.

In operation 1560, when the preset time has elapsed, the refrigerator 100 according to an embodiment of the disclosure may output again the notification about occurrence of the abnormal state of the refrigerator 100. The refrigerator 100 may control the sound output interface 121 to output again the notification about occurrence of the abnormal state of the refrigerator 100.

In operation 1570, when the refrigerator 100 according to an embodiment of the disclosure determines that the time during which the user input for the at least one key is maintained is equal to or greater than 2n seconds, the refrigerator 100 may control the output interface 120 to maintain a state in which the notification about occurrence of the abnormal state of the refrigerator 100 is turned off until a first situation occurs. For example, the first situation may correspond to a situation in which a user input for the at least one key is obtained even when the notification about occurrence of the abnormal state of the refrigerator 100 is turned off or a situation in which the abnormal state of the refrigerator 100 has been resolved. For example, when the refrigerator 100 determines that the user input is maintained long for 2n seconds or more, the refrigerator 100 may turn off the notification about occurrence of the abnormal state of the refrigerator 100 until the first situation occurs.

In operation 1580, the refrigerator 100 according to an embodiment of the disclosure may identify whether the first situation occurred. For example, the refrigerator 100 may identify whether a user has controlled the notification about occurrence of the abnormal state to be turned on again, by inputting the at least one key. When there is the user input for the at least one key, the refrigerator 100 may release a notification off function with respect to abnormal state occurrence.

Alternatively, for example, the refrigerator 100 may identify whether the abnormal state of the refrigerator 100 is resolved. For example, the refrigerator 100 may identify whether a door open state has been resolved as the door 1630 is closed. When the door open state has been resolved as the door 1630 is closed, the refrigerator 100 may release the notification off function with respect to abnormal state occurrence.

In operation 1590, the refrigerator 100 according to an embodiment of the disclosure may output again the notification about occurrence of the abnormal state of the refrigerator 100. The refrigerator 100 may output again the notification so as to release the notification off function with respect to abnormal state occurrence. The refrigerator 100 may control the sound output interface 121 to output again the notification about occurrence of the abnormal state of the refrigerator 100.

According to an embodiment of the disclosure, the refrigerator 100 may differently perform an operation of controlling a notification with respect to abnormal state occurrence, according to a time during which a user input for the at least one key is maintained while the refrigerator 100 is identified as being in the abnormal state. Accordingly, the user may turn off the notification with respect to abnormal state occurrence in the refrigerator 100 by a user-desired time, so that user convenience may be improved.

FIG. 16 is a diagram illustrating a refrigerator, a control device, a device management server, a terminal, and a service center, according to an embodiment of the disclosure.

Referring to FIG. 16, a refrigerator management system according to an embodiment of the disclosure may include a control device 200, the device management server 300, a terminal 400, and a service center 500, as well as the refrigerator 100. The refrigerator 100, the terminal 400, and the service center 500 may operate as client devices capable of communicating with the device management server 300.

The refrigerator 100 may include the processor 110, the output interface 120, the user interface 130, the memory 140, and a communication module 150. As the processor 110, the output interface 120, the user interface 130, and the memory 140 are described with reference to FIG. 2, detailed descriptions thereof are not provided here. The communication module 150 may correspond to the communication module 1500 of FIG. 3. The communication module 150 may communicate with the control device 200, the device management server 300, the terminal 400, or the service center 500 by using a wired or wireless communication network. The communication module 150 may access a communication network via an access point (AP) (not shown) in a home, and may communicate with the device management server 300, the terminal 400, or the service center 500.

The communication module 150 may perform communication with the control device 200 by using an IrDA communication module, a Wi-Fi communication module, or a BLE communication module. The communication module 150 may receive a control signal from the control device 200 for communication with the control device 200. The processor 110 may receive the control signal from the control device 200 via the communication module 150.

The control device 200 may be implemented as one of various devices used in controlling the refrigerator 100. The control device 200 may receive various types of a user input, e.g., a touch input, a push input, etc., and may include a remote controller capable of remotely controlling the refrigerator 100.

The control device 200 may include a processor 210, the display 220, at least one key 230, a memory 240, and a communication module 250.

The at least one key 230 may receive a user input for controlling the control device 200. The at least one key 230 may be configured as a form of one of a button of receiving a push operation of a user, a touch pad of detecting a user touch, a jog wheel, a jog switch, and a dome switch. The memory 240 may store a predefined operation mapped to the at least one key 230. The processor 210 may receive a user input via the at least one key 230. The processor 210 may generate a control signal including the predefined operation mapped to the at least one key 230. The processor 210 may transmit the control signal including the predefined operation to the refrigerator 100 via the communication module 250. The control signal including the predefined operation may be implemented as a Bluetooth type, an IR signal type, a radio frequency (RF) signal type, a Wi-Fi type, etc., according to a type of the communication module 250.

According to an embodiment of the disclosure, when the refrigerator 100 and the control device 200 transmit and receive a signal by performing IR communication, the control device 200 may generate, as an IR signal, the control signal including the predefined operation. For example, the control device 200 may generate an IR signal having a unique frequency allocated to an input at least one key. The control device 200 may transmit the IR signal to the refrigerator 100 by using a communication network.

The device management server 300 may include a communication module for performing communication with an external device. The device management server 300 may communicate with the refrigerator 100, the terminal 400, or the service center 500 via the communication module.

The terminal 400 may correspond to various types of an electronic device with a communication function. The terminal 400 may include a smartphone, a wearable device, a notebook, a netbook, a portable computer such as a tablet PC, etc., but the disclosure is not limited thereto. The terminal 400 may be connected to the device management server 300, and may be a device that displays information provided from the device management server 300. The terminal 400 may transmit and receive information to and from the device management server 300 via a particular application (e.g., a device management application) installed in the terminal 400. The terminal 400 may transmit and receive wireless information to and from the refrigerator 100 via the device management server 300. The terminal 400 may be a user device registered in the device management server 300 via the same account as the refrigerator 100.

When a user executes an application for managing a user device in the terminal 400, the terminal 400 may receive information from the device management server 300 and may display a screen related to the refrigerator 100 on an execution screen of the application. The terminal 400 may be used to control the refrigerator 100.

The service center 500 may be implemented as an electronic device for monitoring an abnormal state of the refrigerator 100. The service center 500 may include a smartphone, a wearable device, a notebook, a netbook, a portable computer such as a tablet PC, etc., which has a communication function, but the disclosure is not limited thereto. The service center 500 may be connected to the device management server 300 via the communication module, and may monitor the refrigerator 100 via information provided from the device management server 300.

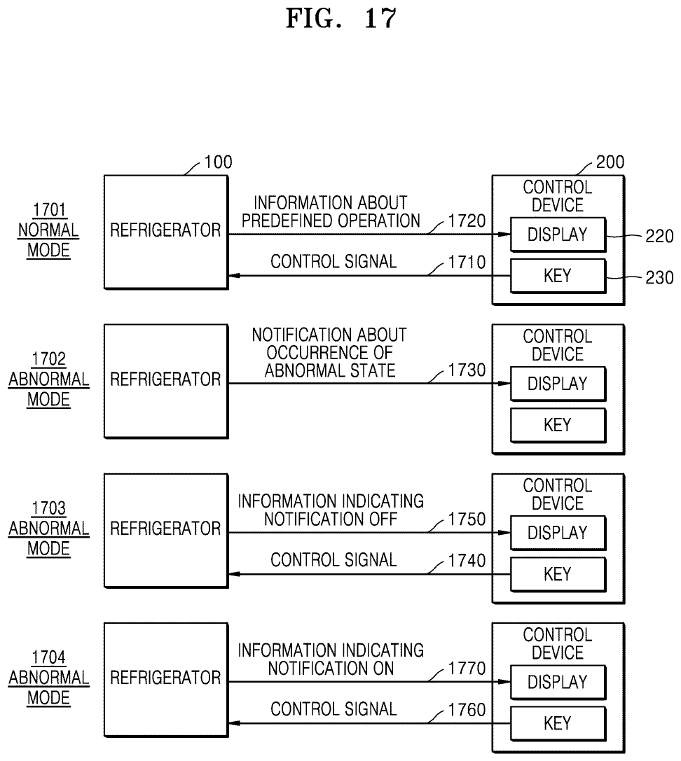

FIG. 17 is a diagram for describing operations of a refrigerator and a control device, according to an embodiment of the disclosure.

Referring to FIG. 17, an operation of controlling, via the control device 200, a notification due to occurrence of an abnormal state of the refrigerator 100 will now be described.

With reference to 1701 of FIG. 17, an operation of the refrigerator 100 according to a normal mode will now be described.

In the normal mode, the control device 200 may receive a user input for the at least one key 230. The control device 200 may generate a control signal for the at least one key 230. The control device 200 may transmit the control signal including a predefined operation to the refrigerator 100. For example, the control signal may be implemented as a Bluetooth type, an IR signal type, a radio frequency (RF) signal type, a Wi-Fi type, etc.

The refrigerator 100 may receive the control signal for the at least one key 230 from the control device 200. The refrigerator 100 may differently process the control signal for the at least one key 230, according to whether the refrigerator 100 operates in a normal mode or an abnormal mode. For example, when the refrigerator 100 in the normal mode receives the control signal for the at least one key 230 from the control device 200, the refrigerator 100 may perform a predefined operation. For example, when the refrigerator 100 in the abnormal mode receives the control signal for the at least one key 230 from the control device 200, the refrigerator 100 may control a notification about occurrence of an abnormal state. In the normal mode, the control signal for the at least one key 230 may be mapped to the predefined operation. In the abnormal mode, the control signal for the at least one key 230 may be mapped to an operation of controlling the notification about occurrence of the abnormal state.

For example, the refrigerator 100 in the normal mode may control a temperature of a fridge compartment to be decreased, based on a control signal including an operation of decreasing the temperature of the fridge compartment.

The refrigerator 100 may transmit information about the predefined operation to the control device 200 (operation 1720). For example, the refrigerator 100 may transmit temperature information of the fridge compartment to the control device 200. The control device 200 may receive the information about the predefined operation from the refrigerator 100. The control device 200 may display the information about the predefined operation on the display 220.

With reference to 1702 of FIG. 17, an operation according to an abnormal mode of the refrigerator 100 will now be described.

When the refrigerator 100 determines that an abnormal state has occurred in the refrigerator 100, the refrigerator 100 may operate in an abnormal mode. The refrigerator 100 may output a notification about occurrence of an abnormal state via a sound output interface.

The refrigerator 100 may transmit the notification about occurrence of the abnormal state to the control device 200 (operation 1730). The control device 200 may control the display 220 to display the notification about occurrence of the abnormal state on the display 220. For example, the control device 200 may display the ‘Ch’ error indicating a malfunction of the refrigerator 100 on the display 220. For example, the control device 200 may display a notice informing a door open state of the refrigerator 100 on the display 220. For example, the control device 200 may display a notice informing a malfunction of a door switch of the refrigerator 100 on the display 220.

With reference to 1703 of FIG. 17, an operation of turning off a notification in an abnormal mode of the refrigerator 100 will now be described.

The control device 200 may receive a user input via the at least one key 230. The control device 200 may generate a control signal for the at least one key 230. The control device 200 may transmit the control signal for the at least one key 230 to the refrigerator 100 (operation 1740).

The refrigerator 100 may receive the control signal for the at least one key 230 from the control device 200. When the refrigerator 100 in the abnormal mode receives the control signal for the at least one key 230 from the control device 200, the refrigerator 100 may control a notification about occurrence of an abnormal state. The refrigerator 100 may control a sound output interface to turn off the notification about occurrence of the abnormal state.

The refrigerator 100 may transmit information indicating that the notification about occurrence of the abnormal state is turned off to the control device 200 (operation 1750). The control device 200 may display, on the display 220, the information indicating that the notification about occurrence of the abnormal state is turned off.

With reference to 1704 of FIG. 17, an operation of turning on a notification in an abnormal mode of the refrigerator 100 will now be described.

The control device 200 may receive again a user input via the at least one key 230. The control device 200 may generate a control signal for the at least one key 230. The control device 200 may transmit the control signal for the at least one key 230 to the refrigerator 100 (operation 1760).

The refrigerator 100 may receive the control signal for the at least one key 230 from the control device 200. When the refrigerator 100 in the abnormal mode receives the control signal for the at least one key 230 from the control device 200, the refrigerator 100 may control a notification about occurrence of an abnormal state. When the refrigerator 100 identifies that the notification about occurrence of the abnormal state is off, the refrigerator 100 may control the sound output interface to turn on the notification about occurrence of the abnormal state. Unlike to this, when the refrigerator 100 identifies that the notification about occurrence of the abnormal state is on, the refrigerator 100 may control again the sound output interface to turn off the notification about occurrence of the abnormal state.

The refrigerator 100 may transmit information indicating that the notification about occurrence of the abnormal state is turned on to the control device 200 (operation 1770). The control device 200 may display, on the display 220, the information indicating that the notification about occurrence of the abnormal state is turned on.

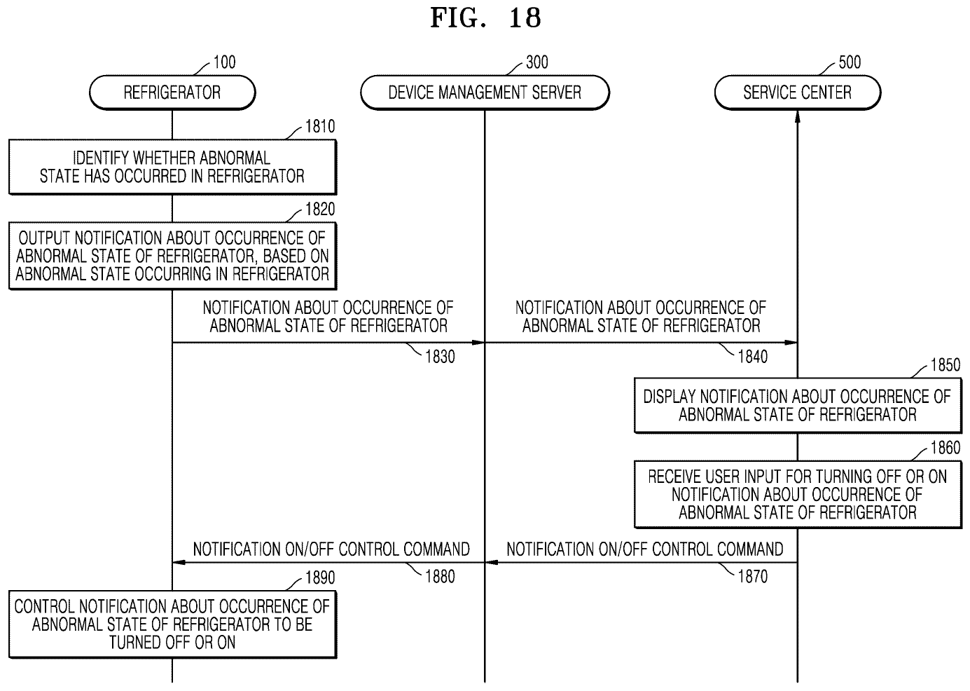

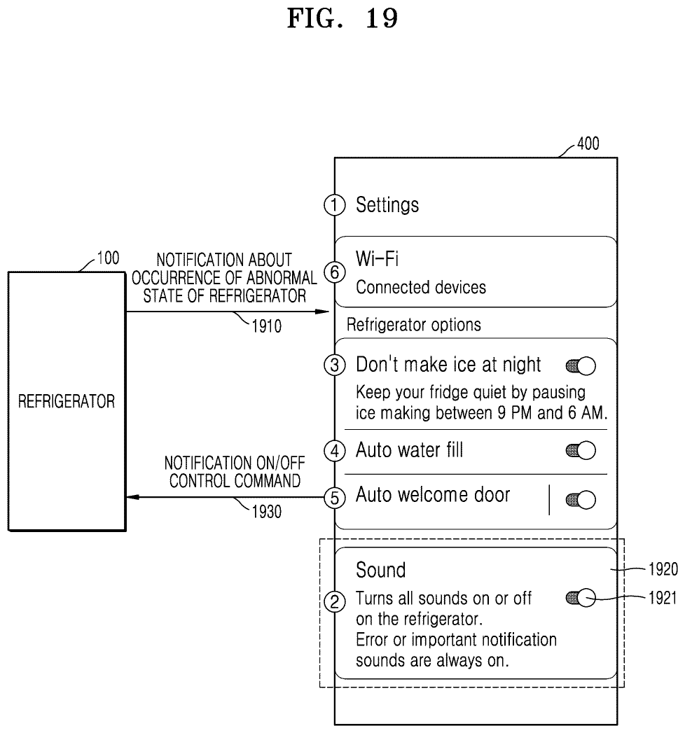

FIG. 18 is a flowchart for describing operations of a refrigerator, a device management server, and a terminal, according to an embodiment of the disclosure. FIG. 19 is a diagram for describing an operation of the terminal according to an operation of the refrigerator, according to an embodiment of the disclosure.

Referring to FIG. 18, in operation 1810, the refrigerator 100 may identify whether an abnormal state has occurred in the refrigerator 100. Operation 1810 may correspond to operation 410 of FIG. 4 or operation 1210 of FIG. 12.

In operation 1820, the refrigerator 100 may output a notification about occurrence of an abnormal state of the refrigerator 100, based on the abnormal state occurring in the refrigerator 100. Operation 1820 may correspond to operation 420 of FIG. 4 or operation 1220 of FIG. 12.

In operation 1830, the refrigerator 100 may transmit the notification about occurrence of the abnormal state of the refrigerator 100 to the device management server 300. The refrigerator 100 may control the communication module 150 to transmit the notification about occurrence of the abnormal state to the device management server 300. The device management server 300 may receive the notification about occurrence of the abnormal state of the refrigerator 100 from the refrigerator 100.

In operation 1840, the device management server 300 may transmit the notification about occurrence of the abnormal state of the refrigerator 100 to the terminal 400. The terminal 400 may receive the notification about occurrence of the abnormal state of the refrigerator 100 from the device management server 300.

In operation 1850, the terminal 400 may display the notification about occurrence of the abnormal state of the refrigerator 100.

The terminal 400 may transmit and receive information to and from the device management server 300 via a device management application installed in the terminal 400. When a user executes an application for managing a user device in the terminal 400, the terminal 400 may receive the notification about occurrence of the abnormal state of the refrigerator 100 from the device management server 300, and may display a notice screen related to the notification about occurrence of the abnormal state of the refrigerator 100, on an execution screen of the application.

For example, referring to FIG. 19, the terminal 400 may receive the notification about occurrence of the abnormal state of the refrigerator 100 from the refrigerator 100 via the device management server 300 (operation 1910). The terminal 400 may display a screen 1920 of the notification about occurrence of the abnormal state of the refrigerator 100, on an execution screen of the application. The terminal 400 may display information indicating that the notification about occurrence of the abnormal state of the refrigerator 100 is able to be controlled.

In operation 1860, the terminal 400 may receive a user input for turning off or on the notification about occurrence of the abnormal state of the refrigerator 100. The terminal 400 may display an icon 1921 for controlling the notification about occurrence of the abnormal state of the refrigerator 100. The icon 1921 is implemented as a left-right scroll form, and when the icon 1921 is moved according to a left scroll, the terminal 400 may generate a control command for turning off the notification, and when the icon 1921 is moved according to a right scroll, the terminal 400 may generate a control command for turning on the notification. A user may move the icon 1921 to the left or the right, and thus, may control the notification about occurrence of the abnormal state of the refrigerator 100 to be turned off or on.

In operation 1870, the terminal 400 may transmit the control command for turning off or on the notification about occurrence of the abnormal state of the refrigerator 100 to the device management server 300. The device management server 300 may receive, from the terminal 400, the control command for turning off or on the notification about occurrence of the abnormal state of the refrigerator 100.

In operation 1880, the device management server 300 may transmit, to the refrigerator 100, the control command for turning off or on the notification about occurrence of the abnormal state of the refrigerator 100. The refrigerator 100 may receive, from the device management server 300, the control command for turning off or on the notification about occurrence of the abnormal state of the refrigerator 100. For example, referring to FIG. 19, the refrigerator 100 may receive the control command for turning off or on the notification from the terminal 400 via the device management server 300 (operation 1930).

In operation 1890, the refrigerator 100 may control the notification about occurrence of the abnormal state of the refrigerator 100 to be turned off or on, based on the control command for turning off or on the notification about occurrence of the abnormal state of the refrigerator 100.

When the refrigerator 100 receives the control command for turning off or on the notification about occurrence of the abnormal state of the refrigerator 100, the refrigerator 100 may control the sound output interface 121 to turn off the notification about occurrence of the abnormal state of the refrigerator 100. The sound output interface 121 may not output the notification about occurrence of the abnormal state.

When the refrigerator 100 receives the control command for turning off or on the notification about occurrence of the abnormal state of the refrigerator 100, the refrigerator 100 may control the sound output interface 121 to turn on the notification about occurrence of the abnormal state of the refrigerator 100. The sound output interface 121 may output the notification about occurrence of the abnormal state.

FIG. 20 is a flowchart for describing operations of a refrigerator, a device management server, and a service center, according to an embodiment of the disclosure.

Referring to FIG. 20, in operation 2005, the refrigerator 100 may identify whether an abnormal state has occurred in the refrigerator 100. Operation 2010 may correspond to operation 410 of FIG. 4 or operation 1210 of FIG. 12.

In operation 2010, the refrigerator 100 may output a notification about occurrence of an abnormal state of the refrigerator 100, based on the abnormal state occurring in the refrigerator 100. Operation 2020 may correspond to operation 420 of FIG. 4 or operation 1220 of FIG. 12.

In operation 2015, according to a user input for at least one key, the refrigerator 100 may control the sound output interface 121 to turn off the notification about occurrence of the abnormal state of the refrigerator 100. Operation 2015 may correspond to operation 430 of FIG. 4 or operation 1240 of FIG. 12.

In operation 2020, the refrigerator 100 may transmit a notification release history of abnormal state occurrence of the refrigerator 100 to the device management server 300. The refrigerator 100 may control the communication module 150 to transmit the notification release history of abnormal state occurrence to the device management server 300. The device management server 300 may receive the notification release history of abnormal state occurrence from the refrigerator 100.

According to an embodiment of the disclosure, the refrigerator 100 may also transmit a cause of the abnormal state of the refrigerator 100 to the device management server 300 and the service center 500. For example, the refrigerator 100 may transmit information as to whether it is a malfunction of the refrigerator 100 due to an abnormality in information stored in the refrigerator 100, whether it is a door open state, or whether it is a malfunction of a door switch to the device management server 300 and the service center 500.

In operation 2025, the device management server 300 may transmit the notification release history of abnormal state occurrence to the service center 500. The service center 500 may receive the notification release history of abnormal state occurrence from the device management server 300.

In operation 2030, the service center 500 may store the notification release history. The service center 500 may receive the notification release history of abnormal state occurrence from the refrigerator 100 via the device management server 300. A service engineer who monitors a PC of the service center 500 may check the notification release history of abnormal state occurrence of the refrigerator 100.

When the refrigerator 100 turns off a notification about occurrence of an abnormal state, the refrigerator 100 may transmit information indicating that the notification about occurrence of the abnormal state is turned off to the service center 500 via the device management server 300. Even when the notification is turned off by user control, the refrigerator 100 may transmit the information to the service center 500 so as to prevent repair of the abnormal state of the refrigerator 100 from being omitted.

In operation 2035, the service center 500 may receive a user input for turning off or on the notification about occurrence of the abnormal state of the refrigerator 100. The service center 500 may generate a control command for turning off or on the notification about occurrence of the abnormal state of the refrigerator 100. Here, a user of the service center 500 may be a service engineer.

In operation 2040, the service center 500 may transmit the control command for turning off or on the notification about occurrence of the abnormal state of the refrigerator 100 to the device management server 300. The device management server 300 may receive the control command for turning off or on the notification about occurrence of the abnormal state of the refrigerator 100 from the service center 500.

In operation 2045, the device management server 300 may transmit, to the refrigerator 100, the control command for turning off or on the notification about occurrence of the abnormal state of the refrigerator 100. The refrigerator 100 may receive the control command for turning off or on the notification about occurrence of the abnormal state of the refrigerator 100 from the device management server 300.

In operation 2050, based on the control command for turning off or on the notification about occurrence of the abnormal state of the refrigerator 100, the refrigerator 100 may control the notification about occurrence of the abnormal state of the refrigerator 100 to be turned off or on.

A service engineer may remotely control the notification about occurrence of the abnormal state of the refrigerator 100 to be turned off or on. Accordingly, even when a user of the refrigerator 100 cannot control the notification about occurrence of the abnormal state of the refrigerator 100, the service engineer may remotely control the notification about occurrence of the abnormal state. Accordingly convenience of the user of the refrigerator 100 may be improved.

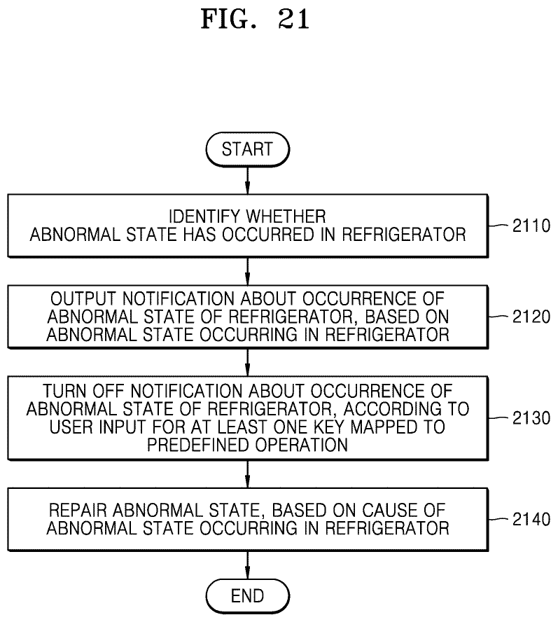

FIG. 21 is a flowchart illustrating a method by which a refrigerator controls a notification about occurrence of an abnormal state, and repairs the abnormal state, according to an embodiment of the disclosure.

Referring to FIG. 21, in operation 2110, the refrigerator 100 according to an embodiment of the disclosure may identify whether an abnormal state has occurred in the refrigerator 100. Operation 2110 may correspond to operation 410 of FIG. 4 or operation 1210 of FIG. 12.

For example, the abnormal state of the refrigerator 100 may indicate a malfunction such as a malfunction of a function of the refrigerator 100 which needs to be repaired by a service engineer. Also, the abnormal state of the refrigerator 100 may indicate a door open state in which a door of the refrigerator 100 is open during a preset time or longer. Also, the abnormal state of the refrigerator 100 may indicate a malfunction such as a malfunction of a door switch of the refrigerator 100 which needs to be repaired by a service engineer.

Alternatively, the abnormal state of the refrigerator 100 may further include a repairable malfunction other than the aforementioned situations. The refrigerator 100 may identify whether the refrigerator 100 has a repairable malfunction. When the refrigerator 100 has the repairable malfunction, the refrigerator 100 may determine that an abnormal state has occurred in the refrigerator 100. The refrigerator 100 may operate according to an abnormal mode.

For example, the repairable malfunction may indicate a malfunction such as an abnormal temperature error of a storage compartment, a de-icing operation error of an ice maker, etc., which does not need to be repaired by a service engineer.

In operation 2120, the refrigerator 100 according to an embodiment of the disclosure may output a notification about occurrence of the abnormal state of the refrigerator 100, based on the abnormal state occurring in the refrigerator 100. Operation 2120 may correspond to operation 420 of FIG. 4 or operation 1220 of FIG. 12.

The refrigerator 100 may output the notification about occurrence of the abnormal state of the refrigerator 100, based on the repairable malfunction occurring.

In operation 2130, according to a user input for at least one key mapped to a predefined operation, the refrigerator 100 according to an embodiment of the disclosure may control the sound output interface 121 to turn off the notification about occurrence of the abnormal state of the refrigerator 100. Operation 2130 may correspond to operation 430 of FIG. 4 or operation 1240 of FIG. 12.

In operation 2140, the refrigerator 100 according to an embodiment of the disclosure may identify a cause of the abnormal state occurring in the refrigerator 100, and may repair the abnormal state.

As the refrigerator 100 receives a user input of turning off the notification about occurrence of the abnormal state of the refrigerator 100, the refrigerator 100 may automatically perform a malfunction repair operation, in correspondence to a cause of a malfunction.

According to an embodiment of the disclosure, a temperature-adjustment compartment of the refrigerator 100 has to be within a temperature range set by a user, and when the temperature-adjustment compartment exceeds the set temperature range, it may be notified that there is an error in an abnormal temperature of the temperature-adjustment compartment. Based on the abnormal temperature error of the temperature-adjustment compartment, the refrigerator 100 may output a notification about occurrence of the abnormal state to the sound output interface 121. Also, based on the abnormal temperature error of the temperature-adjustment compartment, the refrigerator 100 may output the notification about occurrence of the abnormal state to the display 122.

According to a user input for at least one key, the refrigerator 100 may control the sound output interface 121 to turn off a notification about the abnormal temperature error of the temperature-adjustment compartment.

According to the user input for the at least one key, the refrigerator 100 may automatically repair the abnormal temperature error of the temperature-adjustment compartment. For example, the refrigerator 100 may reset a temperature of the temperature-adjustment compartment so as to allow the temperature to be within the temperature range set by the user.

Therefore, according to the user input for the at least one key, the refrigerator 100 may turn off the notification about the abnormal temperature error of the temperature-adjustment compartment, and may repair the abnormal temperature error of the temperature-adjustment compartment.

Alternatively, an ice maker of the refrigerator 100 may perform an ice making operation of making an ice, and a de-icing operation of de-icing and storing the ice in a storage space. When the ice maker does not perform the de-icing operation, the refrigerator 100 may inform that there is an error in the de-icing operation of the ice maker. Based on the de-icing operation error of the ice maker, the refrigerator 100 may output a notification about occurrence of the abnormal state to the sound output interface 121. Also, based on the de-icing operation error of the ice maker, the refrigerator 100 may output the notification about occurrence of the abnormal state to the display 122.

According to a user input for at least one key, the refrigerator 100 may control the sound output interface 121 to turn off a notification about the de-icing operation error of the ice maker.

According to the user input for the at least one key, the refrigerator 100 may automatically repair the de-icing operation error of the ice maker. For example, the refrigerator 100 may stop the ice making operation of the ice maker, and may perform an operation of repairing the de-icing operation. Therefore, according to the user input for the at least one key, the refrigerator 100 may turn off the notification about the de-icing operation error of the ice maker, and may repair the de-icing operation error of the ice maker.

As the refrigerator 100 according to an embodiment of the disclosure may turn off or on a notification about occurrence of an abnormal state, by user control, inconvenience in which a user is exposed to auditory noise may be minimized.

According to an embodiment of the disclosure, the at least one processor 110 may be configured to execute the at least one instruction to perform the predefined operation according to the user input for the at least one key, based on the abnormal state not occurring in the refrigerator 100.

According to an embodiment of the disclosure, the at least one processor 110 may be configured to execute the at least one instruction to identify information about the refrigerator 100, the information being stored in the memory 140. The at least one processor 110 may be configured to determine that there is the abnormal state in the refrigerator 100, based on determining that there is an abnormality in the information about the refrigerator 100.

According to an embodiment of the disclosure, the information about the refrigerator 100 may include information for determining a program for driving the refrigerator 100, according to a function of the refrigerator 100.

According to an embodiment of the disclosure, the at least one processor 110 may be configured to execute the at least one instruction to, when the identified information about the refrigerator 100 is first state information or second state information, or the identified information about the refrigerator 100 identified from at least one storage space among a plurality of spaces of the memory 140 is different from the identified information about the refrigerator 100 identified from other storage spaces among the plurality of spaces, determine that there is the abnormality in the information about the refrigerator 100.

According to an embodiment of the disclosure, the at least one processor 110 may be configured to execute the at least one instruction to determine that there is the abnormal state in the refrigerator 100, based on the at least one door 1630 being open during a preset time or longer. The door 1630 may include at least one door.

According to an embodiment of the disclosure, the at least one processor 110 may be configured to execute the at least one instruction to identify a time during which the user input for the at least one key for turning off the notification about occurrence of the abnormal state of the refrigerator 100 is maintained. The at least one processor 110 may be configured to, when the time during which the user input for the at least one key is maintained is less than 2n seconds, control the output interface 120 to turn off the notification about occurrence of the abnormal state of the refrigerator 100 during a preset time, and to output the notification after an elapse of the preset time.

According to an embodiment of the disclosure, the at least one processor 110 may be configured to execute the at least one instruction to, when the time during which the user input for the at least one key is maintained is equal to or greater than the 2n seconds, control the output interface 120 to maintain a state in which the notification about occurrence of the abnormal state of the refrigerator 100 is turned off until a first situation occurs. The first situation may correspond to a situation in which the user input for the at least one key is obtained even when the notification about occurrence of the abnormal state of the refrigerator 100 is turned off or a situation in which the abnormal state of the refrigerator 100 has been resolved.

According to an embodiment of the disclosure, the user interface 130 may further include a dummy key that is not mapped to a predefined operation. According to an embodiment of the disclosure, the at least one processor 110 may be configured to execute the at least one instruction to, based on the abnormal state occurring in the refrigerator 100, control the display 122 to output information indicating that the dummy key is able to control the notification about occurrence of the abnormal state of the refrigerator 100. The at least one processor 110 may be configured to control the output interface 120 to turn off the notification about occurrence of the abnormal state of the refrigerator 100, according to a user input for the dummy key.

The at least one processor 110 may be configured to execute the at least one instruction to control the communication module 150 to transmit, to an external device, the notification about occurrence of the abnormal state of the refrigerator 100. The at least one processor 110 may be configured to control the communication module to receive, from the external device, a control command for turning off the notification about occurrence of the abnormal state of the refrigerator 100. The external device may include the control device 200, the device management server 300, the terminal 400, and the service center 500.

According to an embodiment of the disclosure, the at least one processor 110 may be configured to execute the at least one instruction to control the communication module 150 to transmit, to an external device, a notification release history related to the notification about occurrence of the abnormal state of the refrigerator 100.

According to an embodiment of the disclosure, a method of controlling the refrigerator 100 includes identifying whether an abnormal state has occurred in the refrigerator 100, controlling the output interface 120 to output a notification about occurrence of the abnormal state of the refrigerator 100, based on the abnormal state occurring in the refrigerator 100, and controlling the output interface 120 to turn off the notification about occurrence of the abnormal state of the refrigerator 100, according to a user input for at least one key mapped to a predefined operation.

According to an embodiment of the disclosure, the method may further include controlling the display 122 to output information indicating that the notification about occurrence of the abnormal state of the refrigerator 100 is turned off, based on the notification about occurrence of the abnormal state of the refrigerator 100 being turned off.

According to an embodiment of the disclosure, the method may further include performing the predefined operation according to the user input for the at least one key, based on the abnormal state not occurring in the refrigerator 100.

According to an embodiment of the disclosure, the identifying of whether the abnormal state has occurred in the refrigerator 100 may include identifying information about the refrigerator 100, the information being stored in the memory 140 of the refrigerator 100, and determining that there is the abnormal state in the refrigerator 100, based on determining that there is an abnormality in the information about the refrigerator 100.

According to an embodiment of the disclosure, the method may further include determining that there is the abnormal state in the refrigerator 100, based on that at least one door 1630 included in the refrigerator 100 is open during a preset time or longer.

According to an embodiment of the disclosure, the method may further include, based on the abnormal state occurring in the refrigerator 100, controlling the display 122 to output information indicating that the dummy key not mapped to a predefined operation is able to control the notification about occurrence of the abnormal state of the refrigerator 100, and controlling the output interface 120 to turn off the notification about occurrence of the abnormal state of the refrigerator 100, according to a user input for the dummy key.

According to an embodiment of the disclosure, the method may further include controlling a communication module 150 to transmit, to an external device, a notification release history related to the notification about occurrence of the abnormal state of the refrigerator 100.

According to an embodiment of the disclosure, the method of the refrigerator 100 may be stored in a computer-readable recording medium having recorded thereon a program to be performed on a computer.

A computer-readable storage medium may be provided in the form of a non-transitory storage medium. Here, the term ‘non-transitory storage medium’ means that the storage medium is a tangible entity and does not include a signal (e.g., an electromagnetic wave), and the term does not distinguish that data is stored semi-permanently or temporarily on the storage medium. For example, the non-transitory storage medium may include a buffer in which data is temporarily stored.

According to an embodiment of the disclosure, the method according to various embodiments disclosed in the present document may be provided in a computer program product. The computer program product may be traded between a seller and a purchaser as a commodity. The computer program product may be distributed in the form of the machine-readable storage medium (e.g., CD-ROM), or may be distributed online (e.g., downloaded or uploaded) through an application store or directly between two user devices (e.g., smart phones). For online distribution, at least a part of the computer program product (e.g., a downloadable application) may be temporarily generated or be at least temporarily stored in a machine-readable storage medium such as a manufacturer's server, an application store's server, or a memory of a relay server.

1. A refrigerator comprising:
an output interface;
a user interface including at least one key mapped to a predefined operation to be performed when the refrigerator is in a normal state, the user interface being configured to receive a user input via the at least one key; and
at least one processor configured to:
identify whether the refrigerator is in an abnormal state,
based on identifying the refrigerator as being in an abnormal state, control the output interface to output a notification of the abnormal state of the refrigerator, and
based on a user input received via the at least one key while the refrigerator is identified as being in the abnormal state, control the output interface to turn off the notification of the abnormal state of the refrigerator.

2. The refrigerator of claim 1, wherein
the output interface includes a display, and
the at least one processor is configured to:
based on the notification of the abnormal state of the refrigerator being turned off, control the display to output information indicating that the notification of the abnormal state of the refrigerator is turned off.

3. The refrigerator of claim 1, wherein
the at least one processor is configured to:
based on the refrigerator not being identified as being in the abnormal state, control the refrigerator to perform the predefined operation according to the user input received via the at least one key.

4. The refrigerator of claim 1, wherein
the at least one processor is configured to:
identify information about the refrigerator, the information being stored in a memory, and
based on determining an abnormality in the identified information, identify that the refrigerator is in the abnormal state.

5. The refrigerator of claim 4, wherein
the information about the refrigerator includes information for determining a program for driving the refrigerator according to a function of the refrigerator.

6. The refrigerator of claim 4, wherein
the at least one processor is configured to:
when the identified information about the refrigerator is first state information or second state information, or the identified information about the refrigerator identified from at least one storage space among a plurality of spaces of the memory is different from the identified information about the refrigerator identified from other storage spaces among the plurality of spaces, determine that there is an abnormality in the information about the refrigerator.

7. The refrigerator of claim 1, further comprising:
at least one door,
wherein the at least one processor is configured to:
based on the at least one door being open during a preset time or longer, identify that the refrigerator is in the abnormal state.

8. The refrigerator of claim 1, wherein
the at least one processor is configured to:
identify a time during which the user input received via the at least one key is maintained while the refrigerator is identified as being in the abnormal state, and
when the time during which the user input received via the at least one key is maintained is less than 2n seconds (wherein n is a positive number):
control the output interface to turn off the notification of the abnormal state of the refrigerator during a preset time, and
control the output interface to output the notification of the abnormal state of the refrigerator after an elapse of the preset time.

9. The refrigerator of claim 8, wherein
the at least one processor is configured to:
when the time during which the user input received via the at least one key is maintained is greater than the 2n seconds, control the output interface to maintain a state in which the notification of the abnormal state of the refrigerator is turned off until:
the user input received via the at least one key is obtained again while the notification of the abnormal state of the refrigerator is turned off, or
the abnormal state of the refrigerator has been resolved.

10. The refrigerator of claim 1, wherein
the output interface includes a display,
the user interface includes a dummy key that is not mapped to a predefined operation to be performed when the refrigerator is in a normal state, and
the at least one processor is configured to:
based on identifying the refrigerator as being in the abnormal state, control the display to output information indicating that the dummy key is able to control the notification of the abnormal state of the refrigerator, and
based on a user input received via the dummy key while the refrigerator is identified as being in the abnormal state, control the output interface to turn off the notification of the abnormal state of the refrigerator.

11. The refrigerator of claim 1, further comprising:
a communication module,
wherein the at least one processor is configured to:
control the communication module to transmit, to an external device, the notification of the abnormal state of the refrigerator, and
control the communication module to receive, from the external device, a control command for turning off the notification of the abnormal state of the refrigerator.

12. The refrigerator of claim 1, further comprising:
a communication module,
wherein the at least one processor is configured to:
control the communication module to transmit, to an external device, a notification release history related to the notification of the abnormal state of the refrigerator.

13. A method of controlling a refrigerator including an output interface, and a user interface including at least one key mapped to a predefined operation to be performed when the refrigerator is in a normal state, the method comprising:
identifying whether the refrigerator is in an abnormal state;
based on identifying the refrigerator as being in an abnormal state, controlling the output interface to output a notification of the abnormal state of the refrigerator; and
based on a user input received via the at least one key while the refrigerator is identified as being in the abnormal state, controlling the output interface to turn off the notification of the abnormal state of the refrigerator.

14. The method of claim 13, wherein
the output interface includes a display, and
the method further comprises:
based on the notification of the abnormal state of the refrigerator being turned off, controlling the display to output information indicating that the notification of the abnormal state of the refrigerator is turned off.

15. The method of claim 13, further comprising:
based on the refrigerator not being identified as being in the abnormal state, performing the predefined operation according to the user input received via the at least one key.

16. The method of claim 13, wherein
the identifying of whether the refrigerator is in an abnormal state includes:
identifying information about the refrigerator, the information being stored in a memory, and
based on determining an abnormality in the identified information, identifying that the refrigerator is in the abnormal state.

17. The method of claim 13, wherein
the refrigerator includes at least one door, and
the method further comprises:
based on the at least one door being open during a preset time or longer, identifying that the refrigerator is in the abnormal state.

18. The method of claim 13, wherein
the output interface includes a display,
the input interface includes a dummy key that is not mapped to a predefined operation to be performed when the refrigerator is in a normal state, and
the method further comprises:
based on identifying the refrigerator as being in the abnormal state, controlling the display to output information indicating that the dummy key is able to control the notification of the abnormal state of the refrigerator, and
based on a user input received via the dummy key while the refrigerator is identified as being in the abnormal state, controlling the output interface to turn off the notification of the abnormal state of the refrigerator.

19. The method of claim 13, wherein
the refrigerator includes a communication module, and
the method further comprises:
controlling the communication module to transmit, to an external device, a notification release history related to the notification of the abnormal state of the refrigerator.

20. A computer-readable recording medium having recorded thereon a program to control a computer to perform the method of claim 13.
